(19) United States
(12) Patent Application Publication
(10) Pub. No.: US 2015/0271515 A1
(43) Pub. Date: Sep. 24, 2015

(54) BLOCK VECTOR CODING FOR INTRA BLOCK COPY IN VIDEO CODING

(71) Applicant: QUALCOMM Incorporated, San Diego, CA (US)

(72) Inventors: Chao Pang, San Diego, CA (US); Ying Chen, San Diego, CA (US); Joel Sole Rojals, La Jolla, CA (US); Marta Karczewicz, San Diego, CA (US)

(21) Appl. No.: 14/592,753

(22) Filed: Jan. 8, 2015

Related U.S. Application Data
(60) Provisional application No. 61/926,224, filed on Jan. 10, 2014.
(60) Provisional application No. 61/994,771, filed on May 16, 2014.
(60) Provisional application No. 62/000,844, filed on May 20, 2014.
(60) Provisional application No. 62/011,389, filed on Jun. 12, 2014.

(51) Int. Cl. H04N 19/513

(52) U.S. Cl. CPC H04N 19/513

(57) ABSTRACT

In various aspects, this disclosure is directed to an example method for decoding video data. The example method includes determining candidate blocks for a block vector prediction process from a subset of candidate blocks used for an advanced motion vector prediction mode or a merge mode for motion vector prediction process; performing the block vector prediction process for a block of video data using the determined candidate blocks; and decoding the block of video data using intra block copy based on the block vector prediction process.

This application claims the benefit of:

U.S. Provisional Patent Application No. 61/926,224, filed 10 Jan. 2014;

U.S. Provisional Patent Application No. 61/994,771, filed 16 May 2014;

U.S. Provisional Patent Application No. 62/000,844, filed 20 May 2014; and

U.S. Provisional Patent Application No. 62/011,389, filed 12 Jun. 2014,

the entire contents of each of which is incorporated herein by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences. For block-based video coding, a video picture or slice may be partitioned into blocks. Each block can be further partitioned. Blocks in an intra-coded (I) picture or slice are encoded using spatial prediction with respect to reference samples in neighboring blocks in the same picture or slice. Blocks in an inter-coded (P or B) picture or slice may use spatial prediction with respect to reference samples in neighboring blocks in the same picture or slice or temporal prediction with respect to reference samples in other reference pictures. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized.

### SUMMARY

This disclosure describes example techniques related to block vector coding for Intra Block Copy coding techniques in a video coding process. Various examples of this disclosure are directed to improving efficiency of coding block vectors (motion vectors) for blocks coded using Intra Block Copy. Several techniques are described herein, and in accordance with this disclosure, video coding devices may implement the techniques separately or in various combinations.

In some aspects, this disclosure is directed to motion vector prediction based on accessing neighbor blocks that form a subset of candidate blocks in accordance with advanced motion vector prediction (AMVP) or prediction according to merge mode. For instance, a video coding device may form a block vector candidate list for a block coded using Intra Block Copy by populating the first two positions of the list with a left candidate and an above candidate. In various implementations, the video coding device may populate the first two positions of the list with a left candidate and an above candidate for an Intra Block Copy-coded block, regardless of the size of the block.

In some aspects, this disclosure is directed to generating virtual candidates to fill a block vector candidate list if all of the candidates for the list are not available. For instance, the video coding device may populate the list using previously coded block vectors. In turn, the video coding device may generate one or more virtual candidates using the block vectors for two other blocks, namely, a block that is positioned to the left of the current block at a distance equal to the width of the current block, and a block that is positioned to the left of the current block at a distance equal to double the width of the current block.

In some aspects, this disclosure is directed to implementing line-buffer constraints. More specifically, a video coding device may implement techniques of this disclosure to reduce resource consumption necessitated by a line buffer. For instance, the video coding device may reduce the data included in the line buffer by disallowing access to an above neighbor that is represented by video data that is in a different row of blocks (e.g., coded tree blocks, or “CTBs”). In some implementations in accordance with this disclosure, the video coding device may apply the line buffer constraint to both inter-coded as well as intra-coded slices of video data.

In some aspects, this disclosure is directed to determining a context used for coding an index for a block vector prediction candidate, in accordance with Intra Block Copy coding techniques. For instance, a video coding device may implement techniques of this disclosure to determine that the context to be used for coding the block vector prediction index in accordance with Intra Block Copy is the same as the context used for coding a candidate index in accordance with AMVP.

In one example, this disclosure is directed to a method for decoding video data, the method including determining candidate blocks for a block vector prediction process from a subset of candidate blocks used for an advanced motion vector prediction mode or a merge mode for motion vector prediction process; performing the block vector prediction process for a block of video data using the determined candidate blocks; and decoding the block of video data using intra block copy based on the block vector prediction process.

In another example, this disclosure is directed to a method for encoding video data, the method including determining candidate blocks for a block vector prediction process from a subset of candidate blocks used for an advanced motion vector prediction mode or a merge mode for motion vector prediction process, performing the block vector prediction process for a block of video data using the determined candidate blocks; and encoding the block of video data using intra block copy based on the block vector prediction process.

In another example, this disclosure is directed to a device for coding video data, the device including a memory configured to store video data, and one or more processors. The one or more processors may be configured to determine candidate blocks for a block vector prediction process from a subset of candidate blocks used for an advanced motion vector prediction mode or a merge mode for motion vector prediction process, perform the block vector prediction process for a block of video data using the determined candidate blocks, and code the block of video data using intra block copy based on the block vector prediction process.

In another example, this disclosure is directed to an apparatus for coding video data. The apparatus may include means for determining candidate blocks for a block vector prediction process from a subset of candidate blocks used for an advanced motion vector prediction mode or a merge mode for motion vector prediction process, means for performing the block vector prediction process for a block of video data using the determined candidate blocks, and means for coding the block of video data using intra block copy based on the block vector prediction process.

In another example, this disclosure is directed to a non-transitory computer-readable storage medium encoded with instructions. The instructions, when executed, may cause one or more processors of a video coding device to determine candidate blocks for a block vector prediction process from a subset of candidate blocks used for an advanced motion vector prediction mode or a merge mode for motion vector prediction process, perform the block vector prediction process for a block of video data using the determined candidate blocks, and code the block of video data using intra block copy based on the block vector prediction process.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system that may implement the techniques of this disclosure.

FIG. 2 is a conceptual diagram illustrating spatial candidate blocks for motion vector prediction.

FIG. 3 is a conceptual diagram illustrating an example of an intra block copying process.

FIG. 4 is a conceptual diagram illustrating example spatial block vector candidates.

FIG. 5 is a block diagram illustrating an example video encoder that may implement the techniques of this disclosure.

FIG. 6 is a block diagram illustrating an example video decoder that may implement the techniques of this disclosure.

FIG. 7 is a flowchart illustrating an example process by which a video decoder may perform various techniques of this disclosure.

FIG. 8 is a flowchart illustrating an example process by which a video encoder may perform various techniques of this disclosure.

### DETAILED DESCRIPTION

This disclosure describes example techniques related to block vector coding for Intra Block Copy video coding techniques. In various examples, the techniques of this disclosure may be used in conjunction with screen content coding.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

For assistance with understanding, the example techniques of this disclosure are described with respect to range extensions (RExt) to the High Efficiency Video Coding (HEVC) video coding standard, including the support of possibly high bit depth (e.g., more than 8 bit), and high chroma sampling format, including 4:4:4 and 4:2:2. The techniques may also be applicable for screen content coding. It should be understood that the techniques are not limited to range extensions or screen content coding, and may be applicable generally to video coding techniques including standards based or non-standards based video coding.

Recently, the design of HEVC has been finalized by the Joint Collaboration Team on Video Coding (JCT-VC) of ITU-T Video Coding Experts Group (VCEG) and ISO/IEC Motion Picture Experts Group (MPEG). One HEVC draft specification, and referred to as HEVC WD hereinafter, is available, from http://phenix.int-evry.fr/jct/doc_end_user/documents/15_Geneva/wg11/JCTVC-O1003-v2.zip, the content of which is incorporated herein by reference in its entirety. HEVC WD is incorporated herein by reference in its entirety. The Range Extensions to HEVC, namely RExt, is also being developed by the JCT-VC. A recent Working Draft (WD) of Range extensions, referred to as “RExt WD7” or simply “RExt” hereinafter, is available, from http://phenix.int-evry.fr/jct/doc_{—}end_user/documents/17_Valencia/wg11/JCTVC-Q1005-v4.zip, the content of which is incorporated herein by reference in its entirety.

In this document the HEVC specification text as in JCTVC-O1003 is often referred to as HEVC version 1. The range extension specification may become the version 2 of the HEVC. However, in a large extent, as far as the proposed techniques are concerned, e.g., motion vector prediction, the HEVC version 1 and the range extension specification are technically similar. Therefore, wherever this disclosure refers to the changes based on HEVC version 1, the same changes may apply to the range extension specification. Conversely, wherever this disclosure reuses the HEVC version 1 module, this disclosure also reuses the HEVC range extension module, with the same sub-clauses.

Recently, investigation of new coding tools for screen-content material, such as text and graphics with motion was requested, and technologies that improve the coding efficiency for screen content have been proposed. During the 17^{th} JCT-VC meeting, screen content coding test model (SCM) was established. The SCM is available at http://phenix.int-evry.fr/jct/doc_end_user/documents/17_Valencia/wg11/JCTVC-Q1014-v1.zip.

In general, the HEVC Range Extension may support video formats that are not specifically supported by the base HEVC specification. The Range Extension of HEVC may include a variety of video coding processes, including Intra block copying, or Intra Block Copy (BC).

For example, with respect to Intra BC, for many applications, such as remote desktop, remote gaming, wireless displays, automotive infotainment, and cloud computing to provide a few examples, the video contents in these applications are usually combinations of natural content, text, artificial graphics and the like. In text and artificial graphics regions, repeated patterns (such as characters, icons, and symbols, to provide a few examples) often exist. Intra Block Copy may refer to what may be characterized as a dedicated process to enable removal of this kind of redundancy. Thus, coding according to Intra Block Copy may thereby potentially improve intra-frame coding efficiency.

At the JCTVC meeting in Vienna (July 2013), Intra Block Copy was adopted in the HEVC Range Extension standard noted above. The techniques described in this disclosure may provide support for applying Intra Block Copy in video coding.

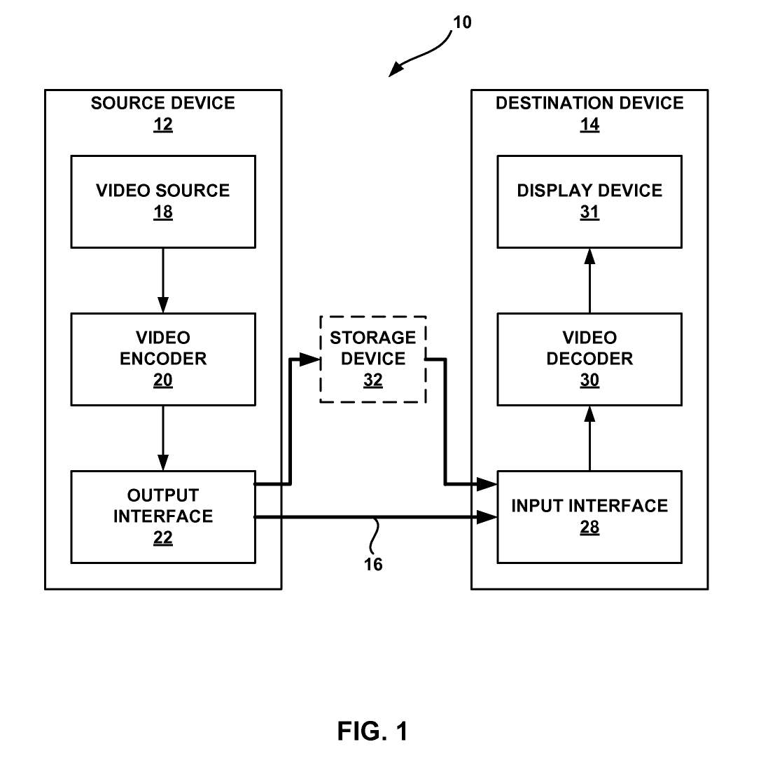

FIG. 1 is a block diagram illustrating an example video encoding and decoding system 10 that may implement the techniques of this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 of source device 12 to a storage device 32. Similarly, encoded data may be accessed from the storage device 32 by input interface 28 of destination device 14. The storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device 32 may correspond to a file server or another intermediate storage device that may store the encoded video generated by source device 12.

Destination device 14 may access stored video data from the storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 31. In accordance with this disclosure, video encoder 20 of source device 12 may be configured to apply the techniques for performing transformation in video coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for intra block copy according to the techniques of this disclosure may be performed by any digital video encoding and/or decoding device. Although generally the techniques of this disclosure are performed by a video encoding or decoding device, the techniques may also be performed by a video codec. Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16 or storage device 32. The information of computer-readable medium 16 or storage device 32 may include syntax information defined by video encoder 20, which is also used by video decoder 30, that includes syntax elements that describe characteristics and/or processing of blocks and other coded units, e.g., GOPs. Display device 31 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (codec). A device including video encoder 20 and/or video decoder 30 may comprise an integrated circuit, a microprocessor, and/or a wireless communication device, such as a cellular telephone.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage device 32) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Video encoder 20 and video decoder 30 may operate according to a video compression standard, such as the HEVC standard. While the techniques of this disclosure are not limited to any particular coding standard, the techniques may be relevant to the HEVC standard, and particularly to the extensions of the HEVC standard, such as the RExt extension and/or screen content coding. The HEVC standardization efforts are based on a model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-five intra-prediction encoding modes.

In general, the working model of the HM describes that a video picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive coding tree units (CTUs). Each of the CTUs may comprise a coding tree block of luma samples, two corresponding coding tree blocks of chroma samples, and syntax structures used to code the samples of the coding tree blocks. In a monochrome picture or a picture that have three separate color planes, a CTU may comprise a single coding tree block and syntax structures used to code the samples of the coding tree block.

A video picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that have three separate color planes, a CU may comprise a single coding block and syntax structures used to code the samples of the coding block. A coding block is an N×N block of samples.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. A prediction block may be a rectangular (i.e., square or non-square) block of samples on which the same prediction is applied. A PU of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples.

TUs may include coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU. A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that have three separate color planes, a TU may comprise a single transform block and syntax structures used to transform the transform block samples.

Following transformation, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan.

After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, picture-based syntax data, and group of pictures (GOP)-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

Video decoder 30, upon obtaining the coded video data, may perform a decoding pass generally reciprocal to the encoding pass described with respect to video encoder 20. For example, video decoder 30 may obtain an encoded video bitstream that represents video blocks of an encoded video slice and associated syntax elements from video encoder 20. Video decoder 30 may reconstruct the original, unencoded video sequence using the data contained in the bitstream.

In HEVC, for each block, a set of motion information may be available. A set of motion information contains motion information for forward and backward prediction directions. As described herein, forward and backward prediction directions are two prediction directions of a bi-directional prediction mode, and the terms “forward” and “backward” do not necessarily imply geometric directions. Instead, as used herein, “forward” and “backward” correspond to reference picture list 0 (RefPicList0) and reference picture list 1 (RefPicList1), respectively, for a current picture. In cases where only one reference picture list is available for a picture or slice, video encoder 20 and/or video decoder 30 may determine that only RefPicList0. Thus, in cases where only one reference picture list is available for a current picture or slice, video encoder 20 and/or video decoder 30 may determine that the motion information of each block of the current picture/slice is always “forward.”

For each prediction direction, the motion information includes a reference index and a motion vector. In some cases, for simplicity, video encoder 20 may encode a motion vector such that the motion vector itself may be referred in a way that it is assumed that it has an associated reference index. For instance, video decoder 30 may reconstruct the motion vector and, based on the motion vector, video decoder 30 may associate a particular reference index with the motion vector. More specifically, video encoder 20 and/or video decoder 30 may use a reference index to identify a particular reference picture in the current reference picture list (e.g., RefPicList0 or RefPicList1) with respect to the corresponding motion vector. A motion vector has a horizontal component and a vertical component.

A picture order count (POC) is widely used in video coding standards to identify a display order of a picture. Although, in some instances, video encoder 20 may encode two pictures within one coded video sequence to have the same POC value, typically, a single coded video sequence may not include multiple pictures with the same POC value. In instances where multiple coded video sequences are present in a bitstream, pictures with a same POC value (but in different video sequences) may be relatively close to each other in terms of decoding order. Video encoder 20 and/or video decoder 30 may typically use POC values of pictures for reference picture list construction, derivation of reference picture set as in HEVC, and motion vector scaling.

The following description is directed to the CU structure in HEVC. In HEVC, the largest coding unit in a slice is referred to as a coding tree block (CTB). A CTB contains a quad-tree the nodes of which are coding units. The size of a CTB can range from 16×16 to 64×64 in the HEVC main profile, although technically, 8×8 CTB sizes can be supported. A coding unit (CU) could be the same size of a CTB although and as small as 8×8. Video encoder 20 and/or video decoder 30 may code each CU according to one mode. When a CU is inter coded, the CU may be further partitioned into two prediction units (PUs). Alternatively, the CU may become just one PU when further partition does not apply. When two PUs are present in one CU, each PU can be a rectangle with half the size (e.g., area) of the CU, or two rectangles each with a size (e.g., area) of one quarter (¼) and three quarters (¾) of the size (e.g., area) of the CU.

In cases where the CU is inter-coded, one set of motion information is present for each PU of the CU. In addition, video encoder 20 and/or video decoder 30 may code each PU using a unique inter-prediction mode to derive the set of motion information. In HEVC, the smallest PU sizes are 8×4 and 4×8. The HEVC standard sets forth two inter-prediction modes, namely, merge mode and advanced motion vector prediction (AMVP) modes, for a PU. According to the HEVC standard, “skip” mode is considered as a special case of merge mode. In either AMVP or merge mode, video encoder 20 and/or video decoder 30 may construct and/or maintain a motion vector (MV) candidate list for multiple motion vector predictors. Video encoder 20 and/or video decoder 30 may implement merge mode coding to generate the motion vector(s), as well as reference indices corresponding to the motion vectors for the current PU are generated. Additionally, video encoder 20 and/or video decoder 30 may implement merge mode coding by taking one candidate from the MV candidate list (e.g., by identifying the candidate using the corresponding reference index).

In cases of merge mode coding, the MV candidate list may include up to 5 candidates. In cases of AMVP coding, the MV candidate list may include two candidates. A merge candidate (i.e., a candidate in an MV candidate list according to merge mode coding) may contain a set of motion information. For example, a merge candidate may include motion vectors corresponding to both reference picture lists (lists 0 and list 1), and reference indices corresponding to the position of each motion vector in the corresponding reference picture list. In cases where a merge candidate is identified by a corresponding merge index, video encoder 20 and/or video decoder 30 may use the reference pictures for the prediction of the current blocks, as well as the associated motion vectors are determined.

According to AMVP mode-based coding, video encoder 20 may encode and signal a reference index explicitly for each potential prediction direction from either list 0 or list 1. More specifically, an AMVP candidate includes only a motion vector. Thus, in AMVP mode, video encoder 20 and/or video decoder 30 may further refine the predicted motion vectors. As discussed above, a merge candidate corresponds to a full set of motion information, while an AMVP candidate contains just one motion vector for each specific prediction direction, and a reference index corresponding to each motion vector. Video encoder 20 and/or video decoder 30 may derive the candidates for both merge and AMVP modes similarly, using the same spatial and temporal neighboring blocks.

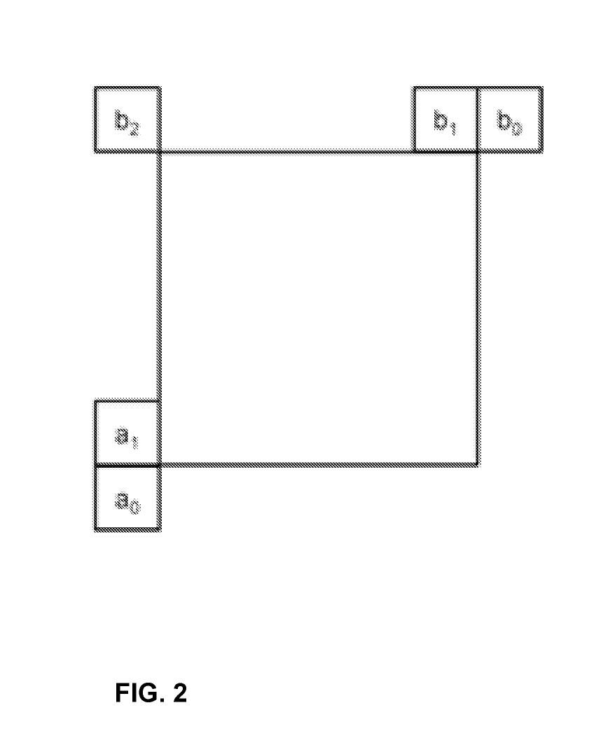

FIG. 2 is a conceptual diagram illustrating spatial candidate blocks for motion vector prediction. Video encoder 20 and/or video decoder 30 illustrated in FIG. 1 may derive spatial MV candidates from the neighboring blocks shown in FIG. 2, for a specific PU (PU₀), where the neighboring blocks are denoted by a₀, a₁, b₀, b₁, and b₂. Video encoder 20 and/or video decoder 30 may generate the MV candidates from the neighboring blocks of FIG. 2 differently for coding according to merge and AMVP modes. For coding according to merge mode, video encoder 20 and/or video decoder 30 may use the neighboring blocks at the positions of five spatial MV candidates shown in FIG. 2. Video encoder 20 and/or video decoder 30 may check the availability of motion information of the illustrated neighbor block positions according to the following order: {a₁, b₁, b₀, a₀, b₂}.

According to AMVP mode-based coding, video encoder 20 and/or video decoder 30 may dive the neighboring blocks of illustrated in FIG. 2 into two groups. The two groups may include a “left” group consisting of the block a₀ and a₁, and an “above” group consisting of the blocks b₀, b₁, and b₂ as shown in FIG. 2. For the left group, video encoder 20 and/or video decoder 30 may check the availability of motion vector candidates from the neighboring blocks according to the following order: {a₀, a₁}. For the above group, video encoder 20 and/or video decoder 30 may check the availability of the motion vector candidates according to the following order: {b₀, b₁, b₂}. For each group, the potential candidate in a neighboring block referring to the same reference picture as that indicated by the signaled reference index has the highest priority (e.g., highest probability) to be chosen by video encoder 20 and/or video decoder 30 to form a final candidate of the group. It is possible that all neighboring blocks do not contain a motion vector pointing to the same reference picture. In other words, in some scenarios, none of the neighboring blocks illustrated in FIG. 2 may provide a motion vector that points to the reference picture indicated by a reference index signaled by video encoder 20. Therefore, if video decoder 30 does not find such a candidate (e.g., which provides a motion vector that points to the same reference picture indicated by the signaled reference index), video decoder 30 may scale the first available candidate to form the final candidate. Thus, video decoder 30 may compensate any temporal distance differences introduced by the first available candidate (e.g., selected as the default candidate).

For chroma coding, the motion vector is derived for the luma component of a current PU/CU, before it is used for chroma motion compensation. The motion vector is scaled, based on the chroma sampling format.

In HEVC, an LCU may be divided into parallel motion estimation regions (MERs) and allow only those neighboring PUs which belong to different MERs from the current PU to be included in the merge/skip MVP list construction process. The size of the MER may be signaled in picture parameter set as log 2_parallel_merge_level_minus2. When MER size is larger than N×N, wherein 2N×2N is the smallest CU size, MER takes effect in a way that a spatial neighboring block, if it is inside the same MER as the current PU, it is considered as unavailable.

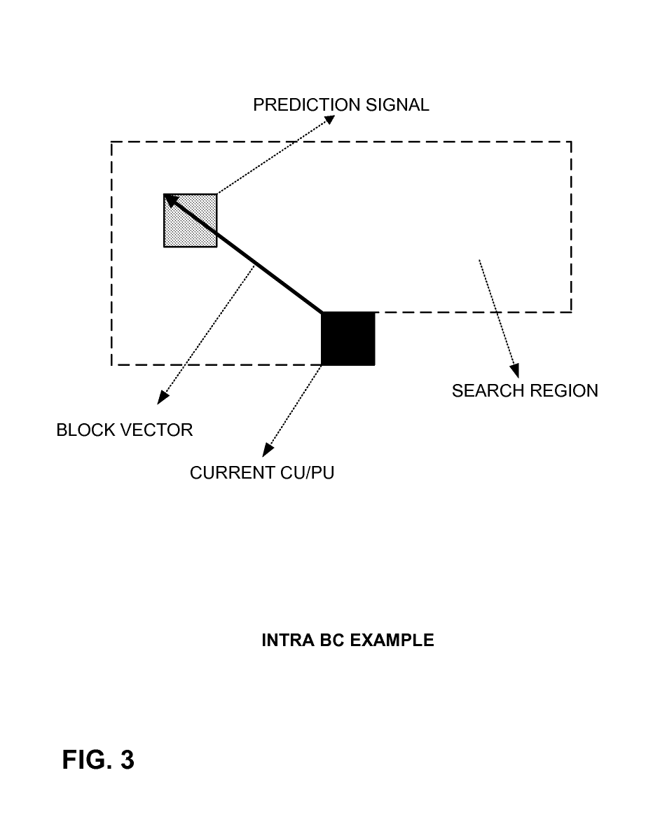

FIG. 3 is a conceptual diagram illustrating an example of an intra block copying process. Intra Block Copy (BC) has been included in the screen content coding test model (SCM). In the example of FIG. 3, a current CU/PU is predicted from an already decoded block of the current picture/slice, e.g., by video encoder 20 and/or video decoder 30. Video encoder 20 and/or video decoder 30 may reconstruct the prediction signal of FIG. 3 without implementing in-loop filtering, including de-blocking and Sample Adaptive Offset (SAO).

According to aspects of this disclosure, video encoder 20 and/or video decoder 30 may apply intra block copying (intra BC). Video encoder 20 may perform an intra BC process to generate a residual block. Intra BC may be a dedicated process that removes redundancy within a picture. For instance, for coding units (CUs) which use intra BC, video encoder 20 or video decoder 30 may obtain the residual block from an already reconstructed region in the same picture. In some instances, video encoder 20 or video decoder 30 may encode or decode, respectively, the offset or displacement vector (also referred to as a motion vector), which indicates the position of the block in the picture used to generate the residual block as displaced from the current CU, together with a residue signal. As illustrated in FIG. 3, for the coding units (CUs) which use intra BC, video encoder 20 and/or video decoder 30 may obtain the prediction signals from the already reconstructed region in the same picture or slice. In turn, video encoder 20 may encode and signal the offset or displacement vector (also referred to as a motion vector or block vector), which indicates the position of the prediction signal in terms of displacement from the current CU, together with the residue signal.

The following describes block compensation. For the luma component or the chroma components that are coded with Intra BC, video encoder 20 and/or video decoder 30 may perform block compensation using integer block compensation. Therefore, video encoder 20 and/or video decoder 30 may not need to perform any interpolation.

The following describes block vector accuracy and block vector derivation. Video encoder 20 may predict and signal a block vector at integer-level precision. In the current SCM, video encoder 20 may set the block vector predictor to (−w, 0) at the beginning of each CTB, where ‘w’ denotes the width of the CU. Additionally, video encoder 20 may update such a block vector predictor to be the block vector of the latest coded CU/PU, provided that particular CU/PU is coded according to Intra BC mode. If a CU/PU is not coded with Intra BC, video encoder 20 may keep the block vector predictor unchanged. After block vector prediction, video encoder 20 may encode the block vector difference using the motion vector difference coding method is HEVC.

The following describes intra BC block size. According to the current specifications of Intra BC coding, video encoder 20 and/or video decoder 30 may enable Intra BC at both the CU and PU levels. At the PU level, according to Intra BC, video encoder 20 and/or video decoder 30 may support 2N×N and N/2N PU partitions for all CU sizes. In addition, in instances where the CU is the smallest CU, video encoder 20 and/or video decoder 30 may support an N×N PU partition.

The following describes block vector predictor methods. Co-pending U.S. Provisional Patent Application No. 61/926,224, filed 10 Jan. 2014, describes several block vector predictor improvement methods, such as using AMVP as in HEVC to select the block vector candidate list, including the temporal block vector in the candidate list, and so on. U.S. Provisional Application No. 61/926,224 is incorporated herein by reference in its entirety.

In Zhu, et al., “Initialization of block vector predictor for intra block copy,” Joint Collaborative Team on Video Coding (JCT-VC) of ITU-T SG 16 WP 3 and ISO/IEC JTC 1/SC 29/WG 11, 16th Meeting: San José, US, 9-17 Jan. 2014 (hereinafter, “JCTVC-P0217”), two previously decoded block vectors are selected as predictor candidates, and a flag is coded to signal or otherwise indicate which predictor is to be used. For instance, according to aspects of JCTVC-P0217, video encoder 20 may encode and signal a flag that indicates to video decoder 30 which predictor is to be used in the decoding process. JCTVC-P0217 is hereby incorporated by reference in its entirety.

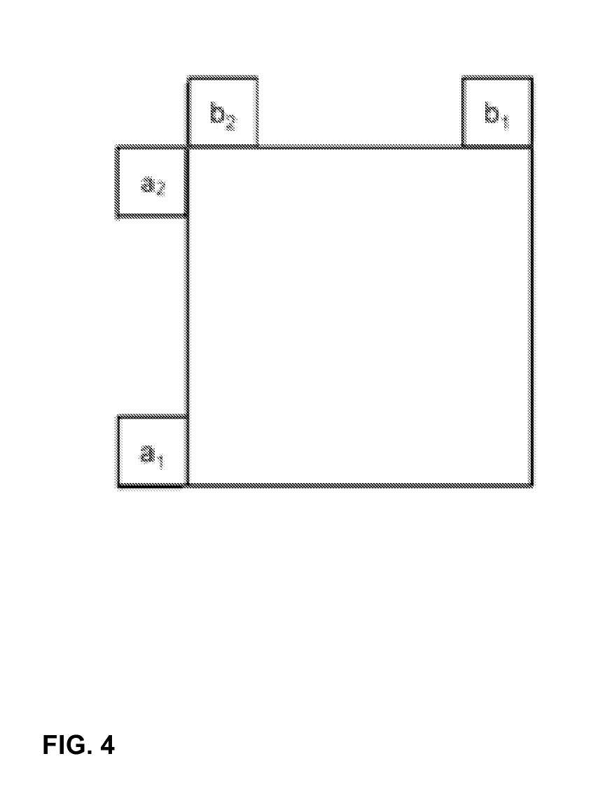

FIG. 4 is a conceptual diagram illustrating example spatial block vector candidates. In Pang, et al. “Block vector prediction method of Intra block copy,” Joint Collaborative Team on Video Coding (JCT-VC) of ITU-T SG 16 WP 3 and ISO/IEC JTC 1/SC 29/WG 11, 17th Meeting: Valencia, E S, 27 Mar.-4 Apr. 2014 (hereinafter, “JCTVC-Q0114”), four spatial block vector predictor candidates as shown in FIG. 4 are divided into two groups. The two groups are a left group including {a₂, a₁} and an above group including {b₂, b₁}. JCTVC-Q0114 is hereby incorporated by reference in its entirety. According to aspects of the JCTVC-Q0114 disclosure, video encoder 20 may choose two spatial block vector predictor candidates, with one from the left group according to availability checking order {a₂, a₁}, and the other one from the above group according to the availability checking order {b₂, b₁}. If one spatial block vector predictor candidates is unavailable, video encoder 20 may use (e.g., substitute a block vector predictor candidate with) motion information from a block located at (−2w, 0) from the current block, where, ‘w’ denotes a width of the current CU. If both spatial block vector predictor candidates are unavailable, video encoder 20 may use (e.g., substitute the block vector predictor candidates with) motion information from the blocks located at (−2*w, 0) and (−w, 0) are used instead, where ‘w’ is the current CU width. In cases where the current block has a size of 4×4, b₂ and b₁ will be the same block, and a₂ and a₁ will be the same block.

In Onno, et al. “AhG5: On the displacement vector prediction scheme for Intra Block Copy,” Joint Collaborative Team on Video Coding (JCT-VC) of ITU-T SG 16 WP 3 and ISO/IEC JTC 1/SC 29/WG 11, 17th Meeting: Valencia, E S, 27 Mar.-4 Apr. 2014 (hereinafter, “JCTVC-Q0062”), the block vector predictor is chosen from three previously decoded block vectors. JCTVC-Q0062 is hereby incorporated by reference in its entirety. In Xu, et al., “On unification of intra block copy and inter-picture motion compensation,” Joint Collaborative Team on Video Coding (JCT-VC) of ITU-T SG 16 WP 3 and ISO/IEC JTC 1/SC 29/WG 11, 16th Meeting: San José, US, 9-17 Jan. 2014 (hereinafter, “JCTVC-Q0132”), the AMVP scheme in HEVC (with only spatial neighbors) is extended to Intra BC to determine the block vector predictor. JCTVC-Q0132 is hereby incorporated by reference in its entirety.

Previous proposals for Intra BC in the HEVC RExt present certain potential problems, some of which are described below. According to aspects of JCTVC-Q0114, some of the spatial neighbor blocks may not be positioned at the neighbor block positions as specified in HEVC AMVP. In cases where the spatial neighbor blocks are not positioned at the specified neighbor block positions, video encoding device 20 and/or video decoding device 30 may require additional logic to access the neighbor blocks, as well as memory accesses. According to aspects of JCTVC-Q0132, the spatial neighbor blocks are identical to the spatial candidates according to AMVP in HEVC version 1. However, implementing Intra BC coding using spatial neighbor blocks as specified in JCTVC-Q0132 might not be efficient, or may be unnecessary from both efficiency and line-buffer perspectives. In previous proposals for Intra BC, the merge mode as in HEVC version 1 is not supported for Intra BC.

Temporal motion vector prediction (TMVP) for Intra BC has been proposed, as described in co-pending U.S. Provisional Patent Application No. 61/926,224. However, a co-located picture used according to TMVP must be stored in the decoded picture buffer (DPB), and motion compression applies. Thus, the compression of normal motion vectors and Intra BC block vectors to meet the buffer requirement as in HEVC version 1 may not be clear.

In view of these potential drawbacks, this disclosure describes various techniques to mitigate or potentially eliminate the issues described above. In various aspects, this disclosure is directed to methods, systems, devices, and techniques for block vector (motion vector) prediction for Intra BC to more efficiently code the block vectors (motion vectors) for Intra BC coded blocks. Various example techniques are described herein. It will be appreciated that the various example techniques described herein may be used separately, or in various combinations.

A general technique of this disclosure is now described. In some embodiments, an AMVP candidate list is created by two steps. The first step is by either collecting up to M motion vectors (from Intra BC blocks) either the neighboring blocks (of the same LCU row) or previously coded blocks (of the same LCU). Available motion vectors are put into the AMVP candidate list until it is full. The second step is to fill in remaining entries in the list of the AMVP candidate list is not empty. Such virtual candidates may be chosen from (−2w, 0), (−w, 0) or (0, −h), (0, −2h), wherein w and h are the width and height of the current CU. In one alternative, the priority/order of the virtual candidates is fixed. In one alternative, the priority/order of the virtual candidates changes depending on the relative position of the current CU within a CTB:—for example, CUs of the leftmost row may prefer (0, −h), (0, −2h) as predictor, and CUs of the topmost row may prefer (−2w, 0), (−w, 0) as predictor. In some alternatives, the maximum number of the candidates in the list, M is equal to 2. Examples for the first step are: In this case, the first candidate is from the left/top TU/PU and the next candidate is from the top/left TU/PU. In another case, the first candidate is from the left/top TU/PU and the next candidate is from the top/left TU/PU and if either of them is not available, the previously available candidate (from a block that is coded with Intra BC, within the CTB) is filled into the AMVP list. An example of the general technique is described below with respect to a first example technique of this disclosure.

According to a first example technique of this disclosure, video encoder 20 and/or video decoder 30 may perform block (motion) vector prediction by accessing the blocks that form a subset of the neighboring blocks accessed during the AMVP or merge processes as specified in HEVC version 1. In one implementation of the first example technique of this disclosure, video encoder 20 and/or video decoder 30 may enable block vector prediction by first accessing neighboring blocks in the following order: {a₁, b₁} to determine the block vector candidate list. If the motion information for the neighboring blocks is available for neighboring blocks a₁ and b₁, video encoder 20 and/or video decoder 30 may add motion information for each blocks a₁ and b₁ to a block vector candidate list for the current block. According to this implementation of the first example technique, video encoder 20 and/or video decoder 30 may access the neighbor block subset of {a₁, b₁} and add the motion information (if available) to the candidate list, for all block sizes of the current block. In other words, according to this example implementation, video encoder 20 and/or video decoder 30 may video encoder 20 and/or video decoder 30 may access the neighbor block subset of {a₁, b₁} and add the motion information (if available) to the candidate list, regardless of the size of the current block.

In another implementation of the first example technique, video encoder 20 and/or video decoder 30 may enable block vector prediction by first accessing in order block a₁ and b₁, if available, and putting each into a block vector candidate list for smaller block sizes, such as only 4×4, or only 4×4, 4×8 and 8×4. For other block sizes (e.g., larger block sizes), video encoder 20 and/or video decoder 30 may implement/apply processes similar to AMVP or merge. According to another aspect of the first example technique, video encoder 20 and/or video decoder 30 may enable block vector prediction by first accessing in order block a₁ and b₁, if available, and putting each into a block vector candidate list for smaller block sizes, such as only 4×4, or only 4×4, 4×8 and 8×4. For other block sizes (e.g., larger block sizes), video encoder 20 and/or video decoder 30 may implement/apply processes similar to the method of checking multiple top neighbors and left neighbors, as in JCTVC-Q0114.

According to a second example technique of the disclosure, video encoder 20 and/or video decoder 30 may generate virtual block vector candidates in scenarios where a block vector candidate list does not include enough candidates, such as a predetermined maximum number. In other words, if video encoder 20 and/or video decoder 30 determine that a block vector candidate list for a current block includes fewer than the requisite (e.g., predetermined maximum) number of candidates for the corresponding coding mode, video encoder 20 and/or video decoder 30 may generate one or more virtual block vector candidates, and use the virtual block vector candidates to populate the block vector candidate list to full capacity.

According to one implementation of the second example technique, video encoder 20 and/or video decoder 30 may populate the block vector candidate list with any available previously-coded block vectors (e.g., from the neighboring blocks described above). In turn, if the available previously-coded block vectors do not fill the block vector candidate list to the predetermined maximum number of candidates (e.g., to full capacity), video encoder 20 and/or video decoder 30 may generate up to two virtual candidates with which to populate the block vector candidate list to the predetermined maximum number of candidates (e.g., to capacity). For instance, video encoder 20 and/or video decoder 30 may generate up to two virtual block vector candidates, using motion information from blocks positioned at locations (−2*w, 0) and (−w, 0) relative to the current block, where ‘w’ denotes the width of the current block. More specifically, in the example described above, video encoder 20 and/or video decoder 30 may generate the virtual block vector candidates using motion information from blocks positioned to the left of the current block, at distances of twice the width of the current block, and equal to the width of the current block, respectively. In a scenario where video encoder 20 and/or video decoder 30 determine that the block vector candidate list requires only one virtual candidate to reach full capacity, video encoder 20 and/or video decoder 30 may generate a single virtual block vector candidate, using motion information from one of the blocks positioned at locations (−2*w, 0) and (−w, 0) relative to the current block.

In some implementations of the second example technique, video encoder 20 and/or video decoder 30 may generate virtual candidates to be used as default block vectors, such as, but not limited to, block vector candidates derived from one or more of blocks positioned at locations (−2w, 0), (2w, 0), (−w, 0), (w, 0), (0, −h), (0, −2h), (0, h), (0, 2h), (−8, 0), (0, 8), (0,0), (−w, −h), (−2w, −2h), (−2w, −h), (−w, −2h) relative to the current block, where ‘w’ and ‘h’ denote the width and height of current block (e.g., CU, PU or CTB), respectively. Alternatively, video encoder 20 and/or video decoder 30 may generate virtual candidates according to the decoding order of the previously (latest) coded block vector(s) of the same CTB.

In a third example technique of the disclosure, video encoder 20 and/or video decoder 30 may constrain one or more of the above motion/block vector prediction methods to potentially reduce the line-buffer. For example, one or more of the methods may be constrained such that video encoder 20 and/or video decoder 30 may impose a line-buffer constraint by disallowing or disable access to an above neighbor which is outside the current CTB row. In determining the block vector candidate list, such an above neighbor is considered as unavailable, according to various implementations of the third example technique by video encoder 20 and/or video decoder 30. By implementing one or more line-buffer constraints in accordance with the third example technique of this disclosure, video encoder 20 and/or video decoder 30 may reduce storage and memory usage, and may mitigate computing resources that would otherwise be expended for accessing the line buffer more frequently. Thus, one or both of video encoder 20 and video decoder 30 may implement the third example technique of this disclosure to improve the efficiency of Intra BC coding.

According to one implementation of the third example technique described above, video encoder 20 and/or video decoder 30 may impose such a line-buffer constraint to any slice of video data that is either inter-coded or intra-coded. In other words, in instances where video encoder 20 and/or video decoder 30 implement the third example technique in this manner, the line-buffer constraint applies to both inter-coded slices and intra-coded slices. Thus, according to the particular implementation described above, video encoder 20 and/or video decoder 30 may apply the third example technique to conserve computing resources by applying the line-buffer constraint of this disclosure to both inter-coded slices and intra-coded slices of video data.

In another implementation of the third example technique, video encoder 20 and/or video decoder 30 may apply such a line-buffer constraint only to intra-coded slices. According to this example implementation the line-buffer for an inter-coded slice may remain the same by sharing the motion vector storage for blocks that are coded with Intra BC, because the Intra BC-coded blocks do not have normal motion vectors, but just block vectors instead. In this case, each 8×8 block in a top CTB row contains only two block vectors for the 4×4 blocks that are adjacent to the next CTB row. In this case, the reference index of the block vector may be set equal to num_ref_idx_{—}1X_active_minus1+1 (with X being 0 or 1, and typically 0), which is larger than any legal reference index for inter prediction references. In case of Intra coding, such a reference index is not required to be stored. Even if a reference index is stored, the reference index video encoder 20 and/or video decoder 30 may apply may set the reference index equal to 0.

Alternatively, and/or in addition to the above-described implementations of the third example technique, one or both of video encoder 20 and video decoder 30 may constrain one or more of the above motion/block vector prediction methods by disallowing accessing a left neighbor which is outside the current CTB. Such a left neighbor (e.g., outside of the current CTB) is considered as unavailable.

Alternatively, and/or in addition to the above-described implementations of the third example technique, one or both of video encoder 20 and video decoder 30 may constrain one or more of the above-described motion/block vector prediction methods may by disallowing accessing a left neighbor which is outside the current CTB. Such a left neighbor (e.g., outside of the current CTB) is considered as unavailable.

A fourth example technique of the disclosure concerns block vectors for temporal motion vector prediction. In one aspect of the fourth example, block vectors are not stored in a picture in DPB, thus temporal motion vector prediction is disabled. In another aspect of the fourth example technique, block vectors are stored in a picture in DPB, thus temporal motion vector prediction is further enabled. When the spatial neighbors do not provide sufficient number of available block vectors, the block vector from temporal neighboring blocks in the same positions as HEVC version 1 TMVP is added into the block vector candidate list. Motion compression applies for block vectors and motion vectors transparently by considering block vectors as motion vectors. In this case, a motion vector/block vector of a fixed 4×4 (top-left) block position of each 16×16 block is kept (or used) for TMVP for each prediction direction corresponding to reference picture list X (with X being equal to 0 or 1), as in HEVC version 1.

Alternatively, when both block vectors and motion vectors are present in a 16×16 block, a motion compression scheme may apply such that one block vector and one motion vector are stored for each 16×16 block. For example, after processing, the top-left 4×4 block contains a block vector corresponding to reference picture list 0 and a motion vector corresponding to reference picture list 1. With such additional processing after a picture is decoded/filtered, and before it is used as a co-located picture by TMVP, the TMVP process can be reused without accessing other blocks as it is designed now in HEVC version 1.

According to a fifth example technique of the disclosure, even when AMVP or any of the above-described methods is enabled, video encoder 20 and/or video decoder 30 may use more than two neighboring blocks to potentially extend the number of hypothesis (i.e., candidates) to be more than 2 (e.g., 3, 4 or 5). In some examples, the number of hypothesis (i.e., candidates) can be fixed. In other examples, video encoder 20 may additionally (e.g., explicitly) signal the number of hypotheses in any one or more of a picture parameter set (PPS) extension, a sequence parameter set (SPS), a video parameter set (VPS), or a slice header. Video encoder 20 and/or video decoder 30 may implement the fifth example technique of this disclosure for block vector prediction, assuming that video encoder 20 signals a motion vector difference (MVD) to enable video decoder 30 to refine the block vector from the predicted block vector. In instances where video decoder 30 receives the MVD with which to derive the block vector from a predicted block vector via refinement, video encoder 20 and/or video decoder 30 may populate the block vector candidate list using neighboring blocks in a manner similar to the manner specified for merge mode in HEVC version 1. For instance, video encoder 20 and/or video decoder 30 may construct the block vector candidate list according to the following order: {a₁, b₁, b₀, a₀, b₂}, provided that block vectors are available for all five specified neighboring blocks.

By extending the hypothesis (e.g., number of candidates) of the block vector candidate list, video encoder 20 and/or video decoder 30 may implement the fifth example technique of this disclosure to improve precision. For instance, by including a greater number of candidates in the block vector candidate list, video encoder 20 and/or video decoder 30 may increase the probability of including more accurate motion information with which to predict the current block. In this manner, video encoder 20 and/or video decoder 30 may implement the fifth example technique of this disclosure to potentially improve coding accuracy and precision with respect to Intra BC coding.

In addition, in a sixth example of the disclosure, the merge mode can be introduced for block vector coding, which e.g., follows the same neighboring block positions and order as in HEVC version 1. In this case, video encoder 20 may not signal MVD as in conventional merge mode. In one aspect of the sixth example, a block vector candidate list contains candidates, each of which is only uni-directionally predicted for Intra BC. Even in the Intra coded block (or Inter coded block), a new skip mode may apply, by e.g., signaling a flag indicating it is a Intra BC skip flag, wherein the new skip mode infers the current block is coded with Intra BC merge mode without residue. As in HEVC version 1, spatial neighbor blocks are considered as unavailable if they are in the same MER as current PU. The MER size for Intra BC can be the same as that for Inter, as by log 2_parallel_merge_level_minus2 in PPS of HEVC version 1. Alternatively, the MER size of Intra BC may be different than the MER size for Inter coded blocks, for example, Intra BC MER size can be larger. Such a size can be additionally signalled in PPS extension, SPS, VPS or slice header, with or without differential coding compared to log 2_parallel_merge_level_minus2. As in HEVC version 1, when the Intra BC CU is partitioned into two PUs (e.g. 2N×N or N×2N), the first PU is considered as unavailable to the second PU. In this case, it is possible to consider a neighboring PU as available if it belongs to a CU coded with N×N that contains the current PU. Alternatively, the motion estimation region (MER) may not apply to Intra BC, however, CU-level merge candidate list generation is required, meaning regardless of the CU partition, all PUs of the same CU share the same merge candidate list as if the CU is coded with 2N×2N partition.

In a seventh example of the disclosure, the block vector prediction and block vector merge mode can be unified. In this case, video encoder 20 may encode and signal a flag similar to merge_flag (namely intra_bc_merge_flag) to indicate the presence of MVD, while the merge and AMVP candidate lists are set to be identical, e.g., the same as the block vector merge candidate list as mentioned above, e.g., with N (e.g. 2) candidates, which is controlled by a syntax element in slice header. Such a syntax element may be shared with five_minus_max_num_merge_c and with normal merge mode for Inter slice or a new syntax element. For an Intra coded slice, video encoder 20 may encode and signal a new syntax element to indicate the number of maximum number of block vector candidates supported in the slice.

When the block is coded with Intra BC skip mode, intra_bc_merge_flag is not present and inferred to be equal to 1, and a residue is not signalled. When MER or CU-level merge as described above applies, alternatively, in addition, the block vector prediction also shares the same candidate list. When MER or CU-level merge as described above applies, alternatively, in addition, and the current mode is not merge (therefore just block vector prediction with MVD signalled), the candidate list can be constructed different than the candidate list if the current PU was coded with a merge mode.

According to an eighth example technique of the disclosure, if video encoder 20 performs block vector prediction is achieved by accessing the blocks that are a subset of the neighboring blocks for AMVP and/or merge processes as in HEVC version 1 (as described in the first example technique of this disclosure), then video decoder 30 may implement the derivation process for a block vector candidate list by reusing the motion vector candidate list derivation process for AMVP or merge in HEVC version 1, with certain assumptions. In one example, video decoder 30 may use only the spatial neighbors located at positions a₁ and b₁ (e.g., the left neighbor and the above neighbor) as block vector predictor candidates for Intra BC AMVP or merge. Video decoder 30 may implement the derivation process of the block vector candidates from neighboring blocks a₁ and b₁ with HEVC AMVP or merge candidate derivation by assuming that motion information for neighboring blocks a₀, b₀, and b₂ are unavailable.

In addition, video decoder 30 may assume the temporal motion vector prediction candidate to be unavailable, with respect to the block vector candidate list. Video decoder 30 may set the availabilities of the above-mentioned neighboring blocks (i.e., blocks a₀, b₀, and b₂) before invoking the motion vector candidate list derivation process (for AMVP or merge), and decoding the current block with Intra BC. By implementing the eighth example technique of this disclosure, video decoder 30 may conserve computing resources and reduce storage requirements. For instance, by constructing a block vector candidate list using a subset of block vector candidates from neighboring blocks a₁ and b₁, video decoder 30 may implement the eight example technique of this disclosure to reduce the amount of motion information to be processed in order to derive the motion information for the current block.

The availabilities of the above mentioned neighboring blocks may be temporally recorded before being reset and after the motion vector candidate list derivation process is invoked, the availabilities of those blocks are reset back to the recorded statues (being available or unavailable).

According to a ninth example technique of this disclosure, video encoder 20 and/or video decoder 30 may code (e.g., encode or decode, respectively) an Intra BC block vector prediction candidate index using the same context as for the AMVP candidate index used for inter-coded blocks. More specifically, video encoder 20 and/or video decoder 30 may use, as the context for coding an Intra BC block vector prediction candidate, the same context an mvp_{—}1X_flag syntax element (e.g., with X being a value of 0 or 1), which is the syntax element that would be used for coding an index for a candidate in an AMVP candidate list. In one example, video encoder 20 and/or video decoder 30 may code the Intra BC block vector predictor candidate index using the same context (e.g., a “shared” context) as the mvp_{—}10_flag syntax element. In such a case, to indicate the Intra BC block vector prediction candidate, video encoder 20 may use a syntax element named “mvp_{—}10_flag.” In some examples, video encoder 20 and/or video decoder 30 may implement the ninth example technique only with respect to inter-coded slices. In accordance with the ninth example technique described herein, video encoder 20 and/or video decoder 30 may reuse the context already determined for AMVP coding, instead of deriving a context explicitly for Intra BC coding. Thus, by implementing the ninth example technique described herein, video encoder 20 and/or video decoder 30 may potentially conserve computing resources and storage requirements, thereby improving the efficiency of Intra BC coding.

In a tenth example of the disclosure, the context used for Intra BC merge (skip) candidate index can be the same as the context of the merge index (merge_idx) used those used for the Inter coded blocks. In such a case, the syntax indicating the Intra BC block merge candidate index and can be named as merge_idx. Note that this technique takes effect only for Inter slices.

In a eleventh example of the disclosure, when both skip and merge mode are supported for Intra BC, rqt_root_cbf is not needed and its value is inferred as 1 if the current CU is coded with merge mode (either Intra BC merge or Inter merge) and its partition mode is PART_{—}2N×2N.

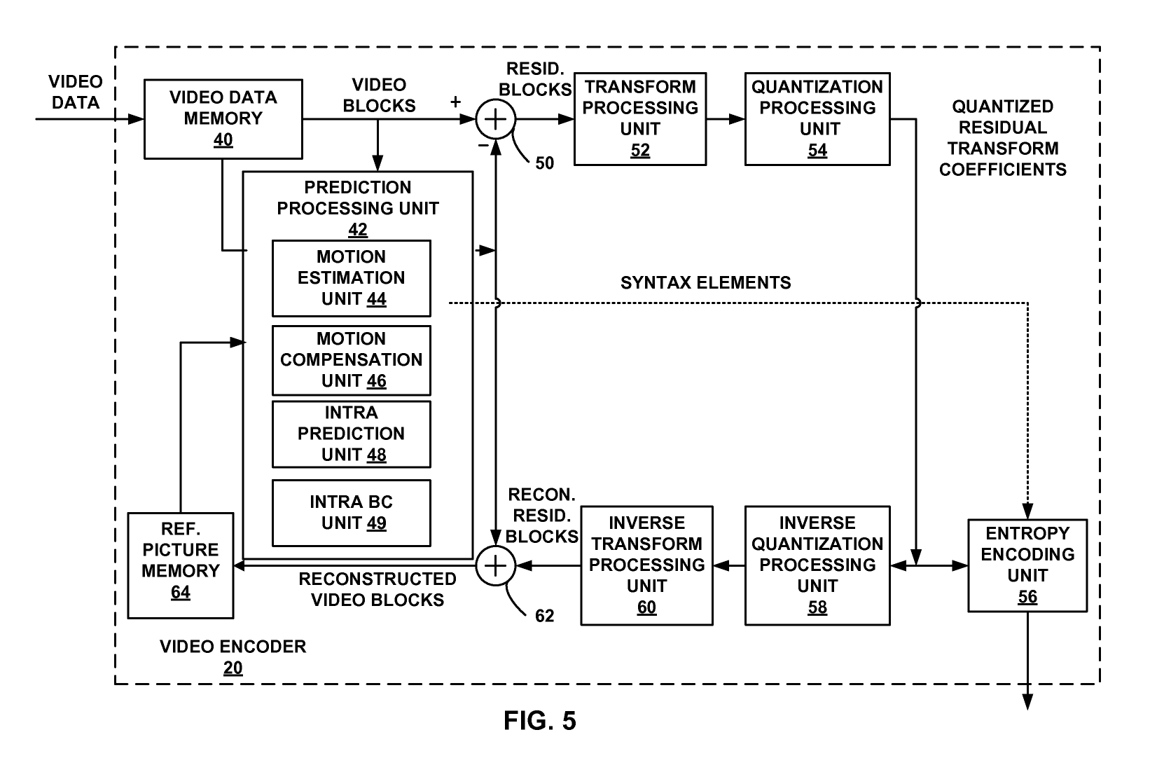

FIG. 5 is a block diagram illustrating an example of a video encoder 20 that may use techniques for intra block copy described in this disclosure. The video encoder 20 will be described in the context of HEVC coding for purposes of illustration, but without limitation of this disclosure as to other coding standards. Moreover, video encoder 20 may be configured to implement techniques in accordance with the range extensions or screen content coding.

Video encoder 20 may perform intra- and inter-coding of video blocks within video slices. Intra-coding relies on spatial prediction to reduce or remove spatial redundancy in video within a given video picture. Inter-coding relies on temporal prediction or inter-view prediction to reduce or remove temporal redundancy in video within adjacent pictures of a video sequence or reduce or remove redundancy with video in other views. Intra-mode (I mode) may refer to any of several spatial based compression modes. Inter-modes, such as uni-directional prediction (P mode) or bi-prediction (B mode), may refer to any of several temporal-based compression modes.

In the example of FIG. 5, video encoder 20 may include video data memory 40, prediction processing unit 42, reference picture memory 64, summer 50, transform processing unit 52, quantization processing unit 54, and entropy encoding unit 56. Prediction processing unit 42, in turn, includes motion estimation unit 44, motion compensation unit 46, intra-prediction unit 48, and intra BC unit 49. For video block reconstruction, video encoder 20 also includes inverse quantization processing unit 58, inverse transform processing unit 60, and summer 62. A deblocking filter (not shown in FIG. 5) may also be included to filter block boundaries to remove blockiness artifacts from reconstructed video. If desired, the deblocking filter would typically filter the output of summer 62. Additional loop filters (in loop or post loop) may also be used in addition to the deblocking filter.

Video data memory 40 may store video data to be encoded by the components of video encoder 20. The video data stored in video data memory 40 may be obtained, for example, from video source 18. Reference picture memory 64 is one example of a decoding picture buffer (DPB) that stores reference video data for use in encoding video data by video encoder 20 (e.g., in intra- or inter-coding modes, also referred to as intra- or inter-prediction coding modes). Video data memory 40 and reference picture memory 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 40 and reference picture memory 64 may be provided by the same memory device or separate memory devices. In various examples, video data memory 40 may be on-chip with other components of video encoder 20, or off-chip relative to those components.

During the encoding process, video encoder 20 receives a video picture or slice to be coded. The picture or slice may be divided into multiple video blocks. Motion estimation unit 44 and motion compensation unit 46 perform inter-predictive coding of the received video block relative to one or more blocks in one or more reference pictures to provide temporal compression or provide inter-view compression. Intra-prediction unit 48 may alternatively perform intra-predictive coding of the received video block relative to one or more neighboring blocks in the same picture or slice as the block to be coded to provide spatial compression. Video encoder 20 may perform multiple coding passes (e.g., to select an appropriate coding mode for each block of video data).

Moreover, a partition unit (not shown) may partition blocks of video data into sub-blocks, based on evaluation of previous partitioning schemes in previous coding passes. For example, the partition unit may initially partition a picture or slice into LCUs, and partition each of the LCUs into sub-CUs based on rate-distortion analysis (e.g., rate-distortion optimization). Prediction processing unit 42 may further produce a quadtree data structure indicative of partitioning of an LCU into sub-CUs. Leaf-node CUs of the quadtree may include one or more PUs and one or more TUs.

Prediction processing unit 42 may select one of the coding modes, intra or inter, e.g., based on error results, and provides the resulting intra- or inter-coded block to summer 50 to generate residual block data and to summer 62 to reconstruct the encoded block for use as a reference picture. Prediction processing unit 42 also provides syntax elements, such as motion vectors, intra-mode indicators, partition information, and other such syntax information, to entropy encoding unit 56.

Motion estimation unit 44 and motion compensation unit 46 may be highly integrated, but are illustrated separately for conceptual purposes. Motion estimation, performed by motion estimation unit 44, is the process of generating motion vectors, which estimate motion for video blocks. A motion vector, for example, may indicate the displacement of a PU of a video block within a current video picture relative to a predictive block within a reference picture (or other coded unit) relative to the current block being coded within the current picture (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 44 may perform a motion search relative to the full pixel positions and fractional pixel positions and output a motion vector with fractional pixel precision.

Motion estimation unit 44 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 44 sends the calculated motion vector to entropy encoding unit 56 and motion compensation unit 46.

Motion compensation, performed by motion compensation unit 46, may involve fetching or generating the predictive block based on the motion vector determined by motion estimation unit 44. Again, motion estimation unit 44 and motion compensation unit 46 may be functionally integrated, in some examples. Upon receiving the motion vector for the PU of the current video block, motion compensation unit 46 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 44 performs motion estimation relative to luma components, and motion compensation unit 46 uses motion vectors calculated based on the luma components for both chroma components and luma components. Prediction processing unit 42 may also generate syntax elements associated with the video blocks and the video slice for use by video decoder 30 in decoding the video blocks of the video slice.

Intra-prediction unit 48 may intra-predict a current block, as an alternative to the inter-prediction performed by motion estimation unit 44 and motion compensation unit 46, as described above. In particular, intra-prediction unit 48 may determine an intra-prediction mode to use to encode a current block. In some examples, intra-prediction unit 48 may encode a current block using various intra-prediction modes, e.g., during separate encoding passes, and intra-prediction unit 48 may select an appropriate intra-prediction mode to use from the tested modes.

For example, intra-prediction unit 48 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 48 may calculate ratios from the distortions and rates for the various encoded blocks to determine which intra-prediction mode exhibits the best rate-distortion value for the block.

Intra BC unit 49 may be configured to perform Intra BC techniques to produce a residual block. In accordance with various aspects of the techniques described in this disclosure, video encoder 20 and, more specifically intra BC unit 49 may generate a residual block for a current block of a picture based on a difference between the current block and a prediction block of the picture. For example, intra BC unit 49 may apply an intra BC process to generate the residual block (as illustrated and described, for example, with respect to FIG. 3). In addition, intra BC unit 49 may be configured to perform the block vector coding techniques of this disclosure, as described herein.

According to various aspects of this disclosure, Intra BC unit 49 may determine candidate blocks for a block vector prediction process from a subset of candidate blocks used for an advanced motion vector prediction (AMVP) mode or a merge mode for a motion vector prediction process. In turn, Intra BC unit 49 may perform the block vector prediction process for a block of video data using the determined candidate blocks. Additionally, entropy encoding unit 56 may encode the block of video data using intra block copy base don the block vector prediction process

Video encoder 20 forms a residual video block by subtracting the prediction data from prediction processing unit 42 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain.

Transform processing unit 52 may send the resulting transform coefficients to quantization processing unit 54. Quantization processing unit 54 quantizes the transform coefficients to further reduce bit rate. The quantization process may reduce the bit depth associated with some or all of the coefficients. The degree of quantization may be modified by adjusting a quantization parameter. In some examples, quantization processing unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization processing unit 58 and inverse transform processing unit 60 apply inverse quantization and inverse transformation, respectively, to reconstruct the residual block in the pixel domain, e.g., for later use as a reference block.

Motion compensation unit 46 may calculate a reference block by adding the residual block to a predictive block of one of the pictures of reference picture memory 64. Motion compensation unit 46 may also apply one or more interpolation filters to the reconstructed residual block to calculate sub-integer pixel values for use in motion estimation. Summer 62 adds the reconstructed residual block to the motion compensated prediction block produced by motion compensation unit 46 to produce a reconstructed video block for storage in reference picture memory 64. The reconstructed video block may be used by motion estimation unit 44 and motion compensation unit 46 as a reference block to inter-code a block in a subsequent video picture.

A filtering unit (not shown) may perform a variety of filtering processes. For example, the filtering unit may perform deblocking. That is, the filtering unit may receive a plurality of reconstructed video blocks forming a slice or a frame of reconstructed video and filter block boundaries to remove blockiness artifacts from a slice or frame. In one example, the filtering unit evaluates the so-called “boundary strength” of a video block. Based on the boundary strength of a video block, edge pixels of a video block may be filtered with respect to edge pixels of an adjacent video block such that the transition from one video block are more difficult for a viewer to perceive.

While a number of different aspects and examples of the techniques are described in this disclosure, the various aspects and examples of the techniques may be performed together or separately from one another. In other words, the techniques should not be limited strictly to the various aspects and examples described above, but may be used in combination or performed together and/or separately. In addition, while certain techniques may be ascribed to certain units of video encoder 20 (such as intra prediction unit 48, motion compensation unit 46, or entropy encoding unit 56) it should be understood that one or more other units of video encoder 20 may also be responsible for carrying out such techniques.

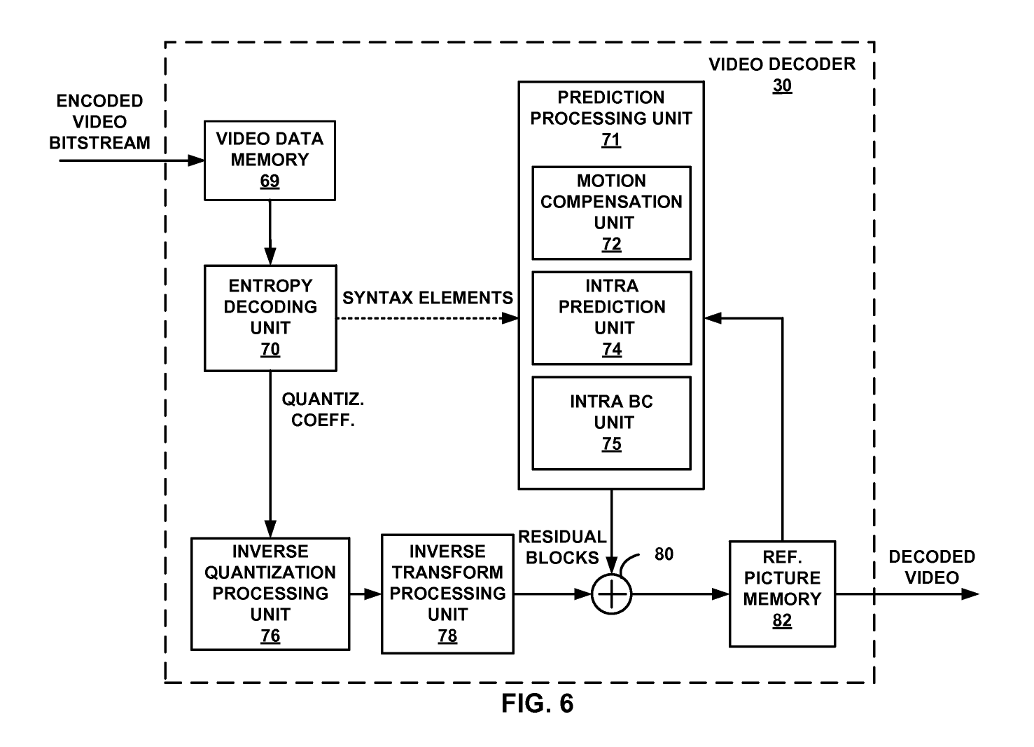

FIG. 6 is a block diagram illustrating an example of video decoder 30 that may implement techniques described in this disclosure. Again, the video decoder 30 will be described in the context of HEVC coding for purposes of illustration, but without limitation of this disclosure as to other coding standards. Moreover, video decoder 30 may be configured to implement techniques in accordance with the range extensions.

In the example of FIG. 6, video decoder 30 may include video data memory 69, entropy decoding unit 70, prediction processing unit 71, inverse quantization processing unit 76, inverse transform processing unit 78, summer 80, and reference picture memory 82. Prediction processing unit 71 includes motion compensation unit 72, intra prediction unit 74, and intra BC unit 75. Video decoder 30 may, in some examples, perform a decoding pass generally reciprocal to the encoding pass described with respect to video encoder 20 from FIG. 5.

Video data memory 69 may store video data, such as an encoded video bitstream, to be decoded by the components of video decoder 30. The video data stored in video data memory 69 may be obtained, for example, from storage device 34, from a local video source, such as a camera, via wired or wireless network communication of video data, or by accessing physical data storage media. Video data memory 69 may form a coded picture buffer (CPB) that stores encoded video data from an encoded video bitstream.

Reference picture memory 82 is one example of a decoded picture buffer (DPB) that stores reference video data for use in decoding video data by video decoder 30 (e.g., in intra- or inter-coding modes). Video data memory 69 and reference picture memory 82 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 69 and reference picture memory 82 may be provided by the same memory device or separate memory devices. In various examples, video data memory 69 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current picture. When the video picture is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Intra BC unit 75 may be configured to perform Intra BC techniques to decode a residual block. In accordance with various aspects of the techniques described in this disclosure, video decoder 30 and, more specifically intra BC unit 75 may decode a residual block of a picture based on a difference between the current block and a prediction block of the picture. For example, intra BC unit 75 may apply an intra BC process to decode the residual block (as illustrated and described, for example, with respect to FIG. 3). In addition, intra BC unit 75 may be configured to perform the block vector coding techniques of this disclosure, as described herein.

According to various aspects of this disclosure, Intra BC unit 75 may determine candidate blocks for a block vector prediction process from a subset of candidate blocks used for an advanced motion vector prediction (AMVP) mode or a merge mode for a motion vector prediction process. In turn, Intra BC unit 75 may perform the block vector prediction process for a block of video data using the determined candidate blocks. Additionally, entropy decoding unit 70 may decode the block of video data using intra block copy base don the block vector prediction process.

Inverse quantization processing unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform processing unit 78 applies an inverse transform, e.g., an inverse DCT, an inverse integer transform, or a conceptually similar inverse transform process, to the transform coefficients in order to produce residual blocks in the pixel domain. Video decoder 30 forms a decoded video block by summing the residual blocks from inverse transform processing unit 78 with the corresponding predictive blocks generated by motion compensation unit 72. Summer 80 represents the component or components that perform this summation operation.

Video decoder 30 may include a filtering unit, which may, in some examples, be configured similarly to the filtering unit of video encoder 20 described above. For example, the filtering unit may be configured to perform deblocking, SAO, or other filtering operations when decoding and reconstructing video data from an encoded bitstream.

While a number of different aspects and examples of the techniques are described in this disclosure, the various aspects and examples of the techniques may be performed together or separately from one another. In other words, the techniques should not be limited strictly to the various aspects and examples described above, but may be used in combination or performed together and/or separately. In addition, while certain techniques may be ascribed to certain units of video decoder 30 it should be understood that one or more other units of video decoder 30 may also be responsible for carrying out such techniques.

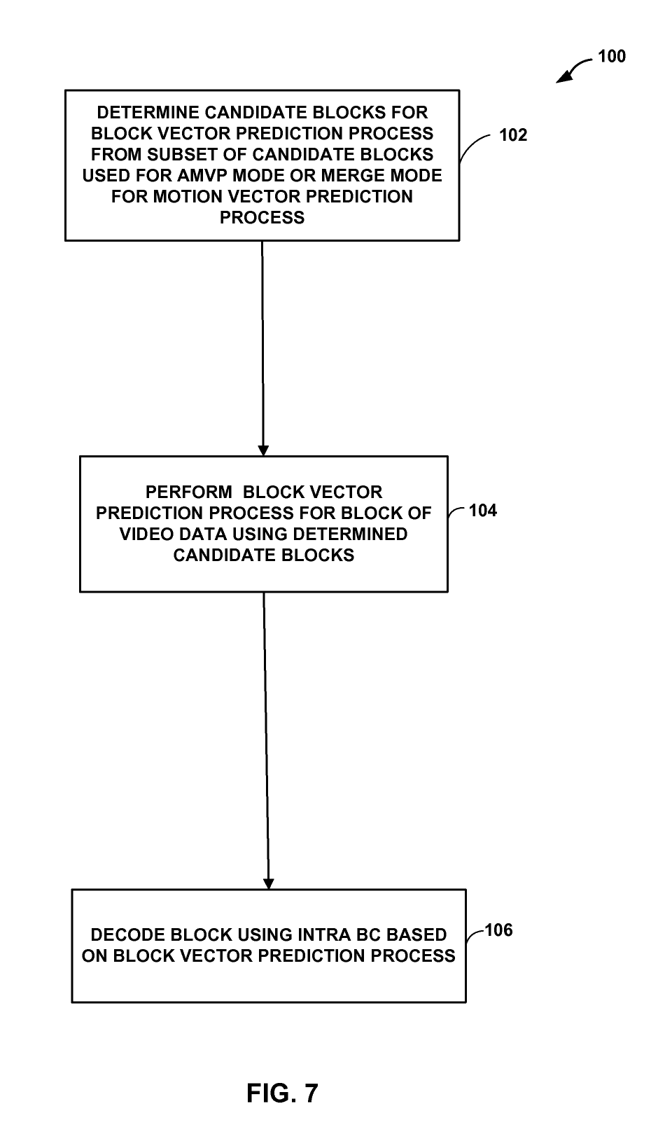

FIG. 7 is a flowchart illustrating an example process 100 by which video decoder 30 (and/or various components thereof) may perform various techniques of this disclosure. Process 100 may begin when Intra BC unit 75 determines candidate blocks for a block vector prediction process from a subset of candidate blocks used for an advanced motion vector prediction (AMVP) mode or a merge mode for a motion vector prediction process (102). In turn, Intra BC unit 75 may perform the block vector prediction process for a block of video data using the determined candidate blocks (104). Additionally, entropy decoding unit 70 may decode the block of video data using intra block copy base don the block vector prediction process (106).

In some examples, Intra BC unit 75 may form a block vector candidate list for the block of video data, such that the block vector candidate list includes motion information associated with the subset of candidate blocks. In one such example, the subset of candidate blocks includes a left neighbor block and an above neighbor block relative to the block of video. In some examples, to determine the candidate blocks, Intra BC unit 75 may perform the block vector prediction process for the block of video data based on the subset of candidate blocks used for the motion vector prediction process for advanced motion vector prediction mode or merge mode, irrespective of a size of the block of video data.

In some examples, Intra BC unit 75 may form a block vector candidate list for the block of video data, such that the block vector candidate list includes motion information associated with the subset of candidate blocks, determining that a number of candidate blocks with available motion information is fewer than a predetermined maximum number of the block vector candidate list, and responsive to determining that the number of the candidate blocks with the available motion information is fewer than the capacity of the block vector candidate list, generating one or more virtual candidates with which to populate the block vector candidate list. In one such example, to generate the one or more virtual candidates, Intra BC unit 75 may use motion information for at least one of: a block located at position (−2w, 0) with respect to the block of video data, or a block located at position (−w, 0) with respect to the block of video data, where ‘w’ denotes a width of the block of video data.

In some examples, to determine the candidate blocks, Intra BC unit 75 may, if an above neighbor block is coded outside of a row of coded tree blocks (CTBs) that includes data for the block of video data, determine that the above neighbor block is unavailable. In one such example, the block of video data is included in an inter-coded slice of video data or in an intra-coded slice of video data.

In some examples, the subset of candidate blocks includes two (2) candidate blocks, and Intra BC unit 75 may extend the subset of candidate blocks to include greater than the two (2) candidate blocks to form an extended subset, and form a block vector candidate list using motion information for each candidate block of the extended subset. In one such example, the extended subset includes a number of candidate blocks between three (3) and five (5). In some examples, the subset of candidate blocks includes a left neighbor block and an above neighbor block with respect to the block of video data, and Intra BC unit 75 may derive motion information for each of the left neighbor block and the above neighbor block using a derivation process defined according to either the advanced motion vector prediction mode or the merge mode. In this example, Intra BC unit 75 may form a block vector candidate list for the block of video data using the derived motion information for each of the left neighbor block and the above neighbor block.

In some examples, Intra BC unit may decode motion information for the subset of candidate blocks using a context used for the advanced motion vector prediction mode only if the block of video data is included in an inter-coded slice of video data, where the context used for the advanced motion vector prediction mode is a context used for coding inter-coded slices of video data according to the advanced motion vector prediction mode.

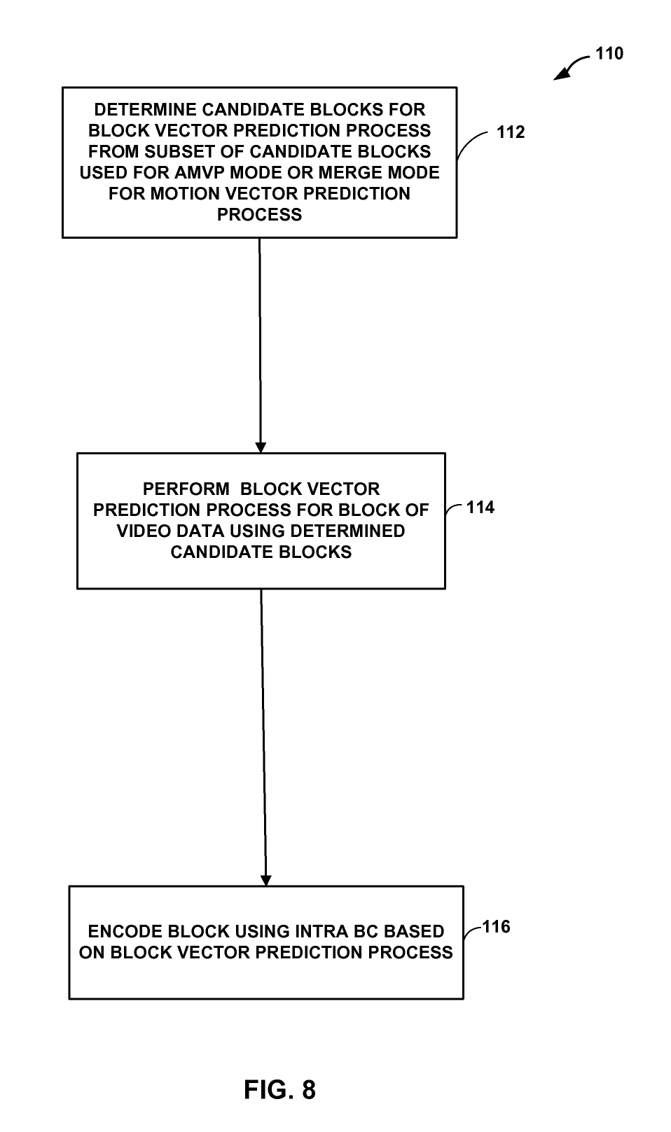

FIG. 8 is a flowchart illustrating an example process 110 by which video encoder 20 (and/or various components thereof) may perform various techniques of this disclosure. Process 110 may begin when Intra BC unit 49 determines candidate blocks for a block vector prediction process from a subset of candidate blocks used for an advanced motion vector prediction (AMVP) mode or a merge mode for a motion vector prediction process (112). In turn, Intra BC unit 49 may perform the block vector prediction process for a block of video data using the determined candidate blocks (114). Additionally, entropy encoding unit 56 may encode the block of video data using intra block copy base don the block vector prediction process (116).

In some examples, Intra BC unit 49 may form a block vector candidate list for the block of video data, such that the block vector candidate list includes motion information associated with the subset of candidate blocks. In one such example, the subset of candidate blocks includes a left neighbor block and an above neighbor block relative to the block of video. In some examples, to determine the candidate blocks, Intra BC unit 49 may perform the block vector prediction process for the block of video data based on the subset of candidate blocks used for the motion vector prediction process for advanced motion vector prediction mode or merge mode, irrespective of a size of the block of video data.

In some examples, Intra BC unit 49 may form a block vector candidate list for the block of video data, such that the block vector candidate list includes motion information associated with the subset of candidate blocks, determining that a number of candidate blocks with available motion information is fewer than a predetermined maximum number of the block vector candidate list, and responsive to determining that the number of the candidate blocks with the available motion information is fewer than the capacity of the block vector candidate list, generating one or more virtual candidates with which to populate the block vector candidate list. In one such example, to generate the one or more virtual candidates, Intra BC unit 49 may use motion information for at least one of: a block located at position (−2w, 0) with respect to the block of video data, or a block located at position (−w, 0) with respect to the block of video data, where ‘w’ denotes a width of the block of video data.

In some examples, to determine the candidate blocks, Intra BC unit 49 may, if an above neighbor block is coded outside of a row of coded tree blocks (CTBs) that includes data for the block of video data, determine that the above neighbor block is unavailable. In one such example, the block of video data is included in an inter-coded slice of video data or in an intra-coded slice of video data.

In some examples, the subset of candidate blocks includes two (2) candidate blocks, and Intra BC unit 49 may extend the subset of candidate blocks to include greater than the two (2) candidate blocks to form an extended subset, and form a block vector candidate list using motion information for each candidate block of the extended subset. In one such example, the extended subset includes a number of candidate blocks between three (3) and five (5). In some examples, the subset of candidate blocks includes a left neighbor block and an above neighbor block with respect to the block of video data, and Intra BC unit 49 may derive motion information for each of the left neighbor block and the above neighbor block using a derivation process defined according to either the advanced motion vector prediction mode or the merge mode. In this example, Intra BC unit 49 may form a block vector candidate list for the block of video data using the derived motion information for each of the left neighbor block and the above neighbor block.

In some examples, Intra BC unit 49 may encode motion information for the subset of candidate blocks using a context used for the advanced motion vector prediction mode only if the block of video data is included in an inter-coded slice of video data, where the context used for the advanced motion vector prediction mode is a context used for coding inter-coded slices of video data according to the advanced motion vector prediction mode.

Embodiments of the techniques of the disclosure described above are shown below with working draft text changes based on the JCTVC-Q1005, the range extension specification. Specification changes that are not in JCTVC-Q1005 are highlighted in bold and italics. Specification changes related to the proposed methods of this disclosure are highlighted in bold and underline. Deletions to JCTVC-Q1005 are shown within double brackets [[ . . . ]].

The embodiments provided in this section assume temporal motion vector prediction (TMVP) for Intra BC is not enabled.

### Embodiment #1

This first example embodiment of the disclosure supports Intra BC with a block vector candidate list. Video encoder 20 and/or video decoder 30 may code (e.g., encode or decode, respectively) the current CU using skip mode and Intra BC mode together. Thus, according to this first example embodiment, video encoder 20 and/or video decoder 30 may use the block vector candidate to derive the block vector directly. According to this first example embodiment, video encoder 20 and/or video decoder 30 may not support a non-skip merge mode (e.g., a “normal merge mode”) for Intra BC coding.

Syntax for the first example embodiment (Embodiment #1) of this disclosure is now described. The syntax for the first example embodiment is described by way of syntax tables 1.1, 1.2, and 1.3 below.

Sequence parameter set RBSP syntax for the first example embodiment is described in Syntax Table 1.1 below.

SYNTAX TABLE 1.1

| | De- |
|---|---|
| | scrip- |
| seq_parameter_set_rbsp( ) { | tor |
| sps_video_parameter_set_id | u(4) |
| sps_max_sub_layers_minus1 | u(3) |
| sps_temporal_id_nesting_flag | u(1) |
| profile_tier_level( sps_max_sub_layers_minus1 ) | |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| scaling_list_enabled_flag | u(1) |
| if( scaling_list_enabled_flag ) { | |
| sps_scaling_list_data_present_flag | u(1) |
| if( sps_scaling_list_data_present_flag ) | |
| scaling_list_data( ) | |
| } | |
| amp_enabled_flag | u(1) |
| sample_adaptive_offset_enabled_flag | u(1) |
| pcm_enabled_flag | u(1) |
| if( pcm_enabled_flag ) { | |
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff_max_min_pcm_luma_coding_block_size | ue(v) |
| pcm_loop_filter_disabled_flag | u(1) |
| } | |
| num_short_term_ref_pic_sets | ue(v) |
| for( i = 0; i < num_short_term_ref_pic_sets; i++) | |
| short_term_ref_pic_set( i ) | |
| long_term_ref_pics_present_flag | u(1) |
| if( long_term_ref_pics_present_flag ) { | |
| num_long_term_ref_pics_sps | ue(v) |
| for( i = 0; i < num_long_term_ref_pics_sps; i++ ) { | |
| lt_ref_pic_poc_lsb_sps[ i ] | u(v) |
| used_by_curr_pic_lt_sps_flag[ i ] | u(1) |
| } | |
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |
| vui_parameters( ) | |
| sps_extension_present_flag | u(1) |
| if( sps_extension_present_flag ) { | |
| sps_range_extensions_flag | u(1) |
| sps_extension_7bits | u(7) |
| } | |
| if( sps_range_extensions_flag ) { | |
| transform_skip_rotation_enabled_flag | u(1) |
| transform_skip_context_enabled_flag | u(1) |
| implicit_rdpcm_enabled_flag | u(1) |
| explicit_rdpcm_enabled_flag | u(1) |
| extended_precision_processing_flag | u(1) |
| intra_smoothing_disabled_flag | u(1) |
| high_precision_offsets_enabled_flag | u(1) |
| fast_rice_adaptation_enabled_flag | u(1) |
| cabac_bypass_alignment_enabled_flag | u(1) |
| } | |
| [symbol] | |
| [symbol] | [symbol] |
| [symbol] | |
| if( sps_extension_7bits ) | |
| while( more_rbsp_data( ) ) | |
| sps_extension_data_flag | u(1) |
| rbsp_trailing_bits( ) | |
| } | |

Coding unit syntax for the first example embodiment is described in Syntax Table 1.2 below.

SYNTAX TABLE 1.2

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I \|\| intra_block_copy_enable_flag) | |
| cu_skip_flag[ x0 ][ y0 ] | ae(v) |
| nCbS = ( 1 << log2CbSize ) | |
| if( intra_block_copy_enable_flag && (slice_type != I \|\| | |
| !cu_skip_flag[ x0 ][ y0 ])) | |
| intra_bc_flag[ x0 ][ y0 ] | ae(v) |
| if( cu_skip_flag[ x0 ][ y0 ] ) | |
| prediction_unit( x0, y0, nCbS, nCbS ) | |
| else { | |
| if( slice_type != I && != intra_bc_flag[ x0 ][ y0 ] ) | |
| pred_mode_flag | ae(v) |
| if( CuPredMode[ x0 ][ y0 ] != MODE_INTRA \|\| | |
| intra_bc_flag[ x0 ][ y0 ]\|\| | |
| log2CbSize = = MinCbLog2SizeY ) | |
| part_mode | ae(v) |
| if( CuPredMode[ x0 ][ y0 ] = = MODE_INTRA && ! | |
| intra_bc_flag[ x0 ][ y0 ] ) { | |
| if( PartMode = = PART_2N×2N && pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else { | |
| pbOffset = ( PartMode = = PART_N×N ) ? ( nCbS / 2 ) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| Else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] ) \|\| | |
| ( CuPredMode[ x0 ][ y0 ] = = MODE_INTRA && | |
| intra_bc_flag[ x0 ][ y0 ] ) | |
| rqt_root_cbf | ae(v) |
| if( rqt_root_cbf ) { | |
| MaxTrafoDepth = ( CuPredMode[ x0 ][ y0 ] = = MODE_INTRA | |
| ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Prediction unit syntax for the first example embodiment of this disclosure is described in Syntax Table 1.3 below.

SYNTAX TABLE 1.3

| prediction_unit( x0, y0, nPbW, nPbH ) { | Descriptor |
|---|---|
| if( cu_skip_flag[ x0 ][ y0 ] ) { | |
| if (! intra_bc_flag[ x0 ][ y0 ]) { | |
| if( MaxNumMergeCand > 1 ) | |
| merge_idx[ x0 ][ y0 ] | ae(v) |
| } | |
| Else | |
| intra_bc_merge_idx[ x0 ][ y0 ] | ae(v) |
| } else if ( intra_bc_flag[ x0 ][ y0 ]){ /* Intra BC*/ | |
| mvd_coding( x0, y0, 2) | |
| intra_bc_bvp_flag[ x0 ][ y0 ] | ae(v) |
| } else {/* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

Semantics for the first example embodiment of this disclosure are now described.
Specification changes that are not in JCTVC-Q1005 are highlighted in bold italics.
Specification changes related to the proposed methods of this disclosure are highlighted in bold. Deletions to JCTVC-Q1005 are shown within double brackets [[ . . . ]].
SPS Semantics for the first example embodiment (Embodiment #1) of this disclosure are now described.
intra_block_copy_enabled_flag equal to 1 specifies that intra block copy may be invoked in the decoding process for intra prediction. intra_block_copy_enabled_flag equal to 0 specifies that intra block copy is not applied. When not present, the value of intra_block_copy_enabled_flag is inferred to be equal to 0.
Coding Unit Semantics for the first example embodiment (Embodiment #1) of this disclosure are now described.

intra_bc_flag[x0][y0] equal to 1 specifies that the current coding unit is coded in intra block copy mode. intra_bc_flag[x0][y0] equal to 0 specifies that the current coding unit is coded according to pred_mode_flag. When not present, the value of intra_bc_flag is inferred to be equal to 1 if slice type is equal to I and cu_skip_flag is equal to 1, otherwise the value of intra_bc_flag is inferred to be equal to 0. The array indices x0, y0 specify the location (x0, y0) of the top-left luma sample of the considered coding block relative to the top-left luma sample of the picture.

pred_mode_flag equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1:

If pred_mode_flag is equal to 0, CuPredMode[x][y] is set equal to MODE_INTER.

Otherwise (pred_mode_flag is equal to 1), CuPredMode[x][y] is set equal to MODE_INTRA.

When pred_mode_flag is not present, the variable CuPredMode[x][y] is derived as follows for x=x0 . . . x0+nCbS−1 and y=y0 . . . y0+nCbS−1:

If intra_bc_flag[x0][y0] is equal to 1, CuPredMode[x][y] is inferred to be equal to MODE_INTRA.

Otherwise, if slice_type is equal to I, CuPredMode[x][y] is inferred to be equal to MODE_INTRA.

Otherwise (slice_type is equal to P or B), when cu_skip_flag[x0][y0] is equal to 1, CuPredMode[x][y] is inferred to be equal to MODE_SKIP.

part_mode specifies partitioning mode of the current coding unit. The semantics of part_mode depend on CuPredMode[x0][y0]. The variables PartMode and IntraSplitFlag are derived from the value of part_mode as defined in Table 7-10.

The value of part_mode is restricted as follows:

If CuPredMode[x0][y0] is equal to MODE_INTRA, the following applies:

If intra_bc_flag[x0][y0] is equal to 1, part_mode shall be in the range of 0 to 3, inclusive.

Otherwise (intra_bc_flag[x0][y0] is equal to 0), part_mode shall be equal to 0 or 1.

Otherwise (CuPredMode[x0][y0] is equal to MODE_INTER), the following applies:

If log 2CbSize is greater than MinCbLog2SizeY and amp_enabled_flag is equal to 1, part_mode shall be in the range of 0 to 2, inclusive, or in the range of 4 to 7, inclusive.

Otherwise, if log 2CbSize is greater than MinCbLog2SizeY and amp_enabled_flag is equal to 0, or log 2CbSize is equal to 3, part_mode shall be in the range of 0 to 2, inclusive.

Otherwise (log 2CbSize is greater than 3 and less than or equal to MinCbLog2SizeY), the value of part_mode shall be in the range of 0 to 3, inclusive.

When part_mode is not present, the variables PartMode and IntraSplitFlag are derived as follows:

PartMode is set equal to PART_{—}2N×2N.

IntraSplitFlag is set equal to 0.

Prediction Unit (PU) Semantics for the first example embodiment (Embodiment #1) of this disclosure are now described.

intra_bc_merge_idx[x0][y0] specifies the merging candidate index of the merging candidate list for intra block copy where x0, y0 specify the location (x0, y0) of the top-left luma sample of the considered prediction block relative to the top-left luma sample of the picture.

Alternatively, intra_bc_merge_idx is renamed as merge_index and can share the same context as merge_index used for Inter coded prediction units.

When merge_idx[x0][y0] is not present, it is inferred to be equal to 0.

intra_bc_bvp_flag[x0][y0] specifies the block vector predictor index of the predictor candidate list where x0, y0 specify the location (x0, y0) of the top-left luma sample of the considered prediction block relative to the top-left luma sample of the picture.

When intra_bc_bvp_flag[x0][y0] is not present, it is inferred to be equal to 0.

Alternatively, intra_bc_bvp_flag is renamed as mvp_{—}10_flag and can share the same context as mvp_{—}10_flag used for Inter coded prediction units.

Decoding processes of the first example embodiment (Embodiment #1) of this disclosure are now described. Video decoder 30 of FIGS. 1 and 6 (and/or various components thereof, as illustrated in FIG. 6) may implement one or more of the decoding processes described below.

An example derivation process that video decoder 30 and/or various components thereof may implement for prediction block availability is described below.

Inputs to this process are:

the luma location (xCb, yCb) of the top-left sample of the current luma coding block relative to the top-left luma sample of the current picture,

a variable nCbS specifying the size of the current luma coding block,

the luma location (xPb, yPb) of the top-left sample of the current luma prediction block relative to the top-left luma sample of the current picture,

two variables nPbW and nPbH specifying the width and the height of the current luma prediction block,

a variable partIdx specifying the partition index of the current prediction unit within the current coding unit,

the luma location (xNbY, yNbY) covered by a neighbouring prediction block relative to the top-left luma sample of the current picture.

Output of this process is the availability of the neighbouring prediction block covering the location (xNbY, yNbY), denoted as availableN is derived as follows:

The variable sameCb specifying whether the current luma prediction block and the neighbouring luma prediction block cover the same luma coding block.
If all of the following conditions are true, sameCb is set equal to TRUE:
xCb is less than or equal than xNbY,
yCb is less than or equal than yNbY,
(xCb+nCbS) is greater than xNbY,
(yCb+nCbS) is greater than yNbY.
Otherwise, sameCb is set equal to FALSE.

The neighbouring prediction block availability availableN is derived as follows:
If sameCb is equal to FALSE, the derivation process for z-scan order block availability as specified in subclause 6.4.1 is invoked with (xCurr, yCurr) set equal to (xPb, yPb) and the luma location (xNbY, yNbY) as inputs, and the output is assigned to availableN.
Otherwise, if all of the following conditions are true, availableN is set equal to FALSE:
(nPbW<<1) is equal to nCbS,
(nPbH<<1) is equal to nCbS,
partIdx is equal to 1,
(yCb+nPbH) is less than or equal to yNbY,
(xCb+nPbW) is greater than xNbY.
Otherwise, availableN is set equal to TRUE.

When availableN is equal to TRUE, [[CuPredMode[xNbY][yNbY] is equal to MODE_INTRA, availableN is set equal to FALSE.]]
If CuPredMode[xPb][yPb] is equal to MODE_INTER, and CuPredMode[xNbY][yNbY] is equal to MODE_INTRA, availableN is set equal to FALSE.
Otherwise, if intra_bc_flag[xPb] [yPb] is equal to 1, and intra_bc_flag[xNbY][yNbY] is equal to 0, availableN is set equal to FALSE.

General decoding processes that video decoder 30 and/or various components thereof may implement for coding units (CUs) coded in intra prediction mode are now described.

Inputs to this process are:

a luma location (xCb, yCb) specifying the top-left sample of the current luma coding block relative to the top-left luma sample of the current picture,

a variable log 2CbSize specifying the size of the current luma coding block.

Output of this process is a modified reconstructed picture before deblocking filtering.
The derivation process for quantization parameters as specified in subclause 8.6.1 is invoked with the luma location (xCb, yCb) as input.
A variable nCbS is set equal to 1<<log 2CbSize.
Depending on the values of pcm_flag[xCb][yCb] and IntraSplitFlag, the decoding process for luma samples is specified as follows:

If pcm_flag[xCb][yCb] is equal to 1, the reconstructed picture is modified as follows:

S_{L}[xCb+i][yCb+j]=pcm_sample_luma[(nCbS*j)+i]<<(BitDepth_{Y}−PcmBitDepth_{Y}), with i, j=0 . . . nCbS−1 (8-12)

Otherwise (pcm_flag[xCb][yCb] is equal to 0), if IntraSplitFlag is equal to 0, the following ordered steps apply:

1. When intra_bc_flag[xCb][yCb] is equal to 0, the derivation process for the intra prediction mode as specified in subclause 8.4.2 is invoked with the luma location (xCb, yCb) as input.
2. When intra_bc_flag[xCb][yCb] is equal to 1, the derivation process for block vector components in intra block copying prediction mode as specified in subclause 8.44 is invoked with the luma location (xCb, yCb) and variable log 2CbSize as inputs, and the output being bvIntra.
3. The general decoding process for intra blocks as specified in subclause 8.4.4.1 is invoked with the luma location (xCb, yCb), the variable log 2TrafoSize set equal to log 2CbSize, the variable trafoDepth set equal to 0, the variable predModeIntra set equal to IntraPredModeY[xCb][yCb], the variable predModeIntraBc set equal to intra_bc_flag[xCb][yCb], the variable bvIntra set equal to BvIntra[xCb][yCb], and the variable cIdx set equal to 0 as inputs, and the output is a modified reconstructed picture before deblocking filtering.
Otherwise (pcm_flag[xCb][yCb] is equal to 0 and IntraSplitFlag is equal to 1), for the variable blkIdx proceeding over the values 0 . . . 3, the following ordered steps apply:
   1. The variable xPb is set equal to xCb+(nCbS>>1)*(blkIdx % 2).
   2. The variable yPb is set equal to yCb+(nCbS>>1)*(blkIdx/2).
   3. The derivation process for the intra prediction mode as specified in subclause 8.4.2 is invoked with the luma location (xPb, yPb) as input.
   4. The general decoding process for intra blocks as specified in subclause 8.4.4.1 is invoked with the luma location (xPb, yPb), the variable log 2TrafoSize set equal to log 2CbSize−1, the variable trafoDepth set equal to 1, the variable predModeIntra set equal to IntraPredModeY[xPb][yPb], the variable predModeIntraBc set equal to intra_bc_flag[xCb][yCb], the variable bvIntra set equal to BvIntra[xCb][yCb], and the variable cIdx set equal to 0 as inputs, and the output is a modified reconstructed picture before deblocking filtering.

When ChromaArrayType is not equal to 0, the following applies.

The variable log 2CbSizeC is set equal to

log 2CbSize−(ChromaArrayType==3?0:1).

Depending on the value of pcm_flag[xCb][yCb] and IntraSplitFlag, the decoding process for chroma samples is specified as follows:

If pcm_flag[xCb][yCb] is equal to 1, the reconstructed picture is modified as follows:

S_{Cb}[xCb/SubWidthC+i][yCb/SubHeightC+j]=pcm_sample_chroma[(nCbS/SubWidthC*j)+i]<<(BitDepth_{C}−PcmBitDepth_{C}), with i=0 . . . nCbS/SubWidthC−1, and j=0 . . . nS/SubHeightC−1 (8-13)

S_{Cr}[xCb/SubWidthC+i][yCb/SubHeightC+j]=pcm_sample_chroma[(nCbS/S ubWidthC*(j+nCbS/SubHeightC))+i]<<(BitDepth_{C}−PcmBitDepth_{C}), with i=0 . . . nCbS/SubWidthC−1, and j=0 . . . nS/SubHeightC−1 (8-14)

Otherwise (pcm_flag[xCb][yCb] is equal to 0), if IntraSplitFlag is equal to 0 or ChromaArrayType is not equal to 3, the following ordered steps apply:

1. When intra_bc_flag[xCb][yCb] is equal to 0, the derivation process for the chroma intra prediction mode as specified in 8.4.3 is invoked with the luma location (xCb, yCb) as input, and the output is the variable IntraPredModeC.
2. The general decoding process for intra blocks as specified in subclause 8.4.4.1 is invoked with the chroma location (xCb/SubWidthC, yCb/SubHeightC), the variable log 2TrafoSize set equal to log 2CbSizeC, the variable trafoDepth set equal to 0, the variable predModeIntra set equal to IntraPredModeC, the variable predModeIntraBc set equal to intra_bc_flag[xCb][yCb], the variable bvIntra set equal to BvIntra[xCb][yCb], and the variable cIdx set equal to 1 as inputs, and the output is a modified reconstructed picture before deblocking filtering.
3. The general decoding process for intra blocks as specified in subclause 8.4.4.1 is invoked with the chroma location (xCb/SubWidthC, yCb/SubHeightC), the variable log 2TrafoSize set equal to log 2CbSizeC, the variable trafoDepth set equal to 0, the variable predModeIntra set equal to IntraPredModeC, the variable predModeIntraBc set equal to intra_bc_flag[xCb][yCb], the variable bvIntra set equal to BvIntra[xCb][yCb], and the variable cIdx set equal to 2 as inputs, and the output is a modified reconstructed picture before deblocking filtering.

Otherwise (pcm_flag[xCb][yCb] is equal to 0, IntraSplitFlag is equal to 1 and ChromaArrayType is equal to 3), for the variable blkIdx proceeding over the values 0 . . . 3, the following ordered steps apply:

1. The variable xPb is set equal to xCb+(nCbS>>1)*(blkIdx % 2).
2. The variable yPb is set equal to yCb+(nCbS>>1)*(blkIdx/2).
3. The derivation process for the chroma intra prediction mode as specified in 8.4.3 is invoked with the luma location (xBS xPb, yBS yPb) as input, and the output is the variable IntraPredModeC.
4. The general decoding process for intra blocks as specified in subclause 8.4.5.1 is invoked with the chroma location (xPb, yPb), the variable log 2TrafoSize set equal to log 2CbSizeC−1, the variable trafoDepth set equal to 1, the variable predModeIntra set equal to IntraPredModeC, the variable predModeIntraBc set equal to intra_bc_flag[xCb][yCb], the variable bvIntra set equal to BvIntra[xCb][yCb], and the variable cIdx set equal to 1 as inputs, and the output is a modified reconstructed picture before deblocking filtering.
5. The general decoding process for intra blocks as specified in subclause 8.4.4.1 is invoked with the chroma location (xPb, yPb), the variable log 2TrafoSize set equal to log 2CbSizeC−1, the variable trafoDepth set equal to 1, the variable predModeIntra set equal to IntraPredModeC, the variable predModeIntraBc set equal to intra_bc_flag[xCb][yCb], the variable bvIntra set equal to BvIntra[xCb][yCb], and the variable cIdx set equal to 2 as inputs, and the output is a modified reconstructed picture before deblocking filtering.
Derivation process for block vector components in intra block copy prediction mode Inputs to this process are:

a luma location (xCb, yCb) of the top-left sample of the current luma coding block relative to the top-left luma sample of the current picture,

a variable log 2CbSize specifying the size of the current luma coding block.

Output of this process is the (nCbS)×(nCbS) array of block vectors bvIntra.
The variables nCbS, nCbSw, nCbSh are derived as follows:

nCbS=1<<log 2CbSize (8-25)

nPbSw=nCbS/(PartMode==PART 2N×2N∥PartMode==PART_{—}2N×N?1:2) (8-25)

nPbSh=nCbS/(PartMode==PART 2N×2N∥PartMode==PART_{—}N×2N?1:2) (8-25)

The variable BvpIntra[compIdx] specifies a block vector predictor. The horizontal block vector component is assigned compIdx=0 and the vertical block vector component is assigned compIdx=1.
Depending upon PartMode, the variable numPartitions is derived as follows:

If PartMode is equal to PART_{—}2N×2N, numPartitions is set equal to 1.

Otherwise, if PartMode is equal to either PART_{—}2N×N or PART_N×21V, numPartitions is set equal to 2.

Otherwise (PartMode is equal to PART_N×N), numPartitions is set equal to 4.

The array of block vectors bvIntra is derived by the following ordered steps, for the variable blkIdx proceeding over the values 0 . . . (numPartitions−1):

1. The variable blkInc is set equal to (PartMode==PART 2N×N?2:1).
2. The variable xPb is set equal to xCb+nPbSw*(blkIdx*blkInc % 2).
3. The variable yPb is set equal to yCb+nPbSh*(blkIdx/2), and the variable compIdx can be 0 or 1.
4. Depending upon the number of times this process has been invoked for the current coding tree unit, the following applies:

The subclause 8.4.4.1 is invoked to get the block vector predictor BvpIntra[xPb][yPb].

The bvIntra[xPb][yPb][compIdx] is derived as follows:

bvIntra[xPb][yPb][0]=BvdIntra[xPb][yPb][0]+BvpIntra[xPb][yPb][0]

bvIntra[xPb][yPb][1]=BvdIntra[xPb][yPb][1]+BvpIntra[xPb][yPb][1]

### 8.4.4.1 Derivation Process for Intra Block Copy Block Vector Prediction

Inputs to this process are:

a luma location (xCb, yCb) of the top-left sample of the current luma coding block relative to the top-left luma sample of the current picture,

a variable nCbS specifying the size of the current luma coding block,

a luma location (xPb, yPb) specifying the top-left sample of the current luma prediction block relative to the top-left luma sample of the current picture,

two variables nPbW and nPbH specifying the width and the height of the luma prediction block,

the reference index of the current prediction unit partition refIdxL2

a variable partIdx specifying the index of the current prediction unit within the current coding unit.

Output of this process is the block vector prediction BvpIntra[xPb][yPb].
The motion vector predictor BvpIntra is derived in the following ordered steps:
The motion vector predictor BvpIntra is derived in the following ordered steps:
1. The derivation process for motion vector predictor candidates from neighbouring prediction unit partitions in subclause 8.4.4.2 is invoked with the luma coding block location (xCb, yCb), the coding block size nCbS, the luma prediction block location (xPb, yPb), the luma prediction block width nPbW, the luma prediction block height nPbH, and the partition index partIdx as inputs, and the availability flags availableFlagN and the block vectors bvIntraN, with N being replaced by A or B, as output.
2. The variables bvpIntraVirtual[i](with i being equal to 0 or 1) specify two virtual block vector predictors, and they are derived as follows:

bvpIntraVirtual[0][0]=−2*nPbW, bvpIntraVirtual[0][1]=0;

bvpIntraVirtual[1][0]=2*nPbW, bvpIntraVirtual1[0][1]=0;

3. The block vector predictor candidate list, bvpIntraList, is constructed as follows:

```
      i = 0
if(availableFlagA )
      bvpIntraList[ i++ ] = bvIntraA
if(availableFlagB && bvIntraA!= bvIntraB)
      bvpIntraList[ i++ ] = bvIntraB
for( j=0; j<2 && i<2;j++) {
      if( (j ==1 || bvpIntraList[ 0 ]!= bvpIntraVirtual[ j ] )
                        bvpIntraList[ i++ ]= bvpIntraVirtual[ j ]
}
```

4. The block vector bvIntra[xPb][yPb] is derived as follows.

for (i=0; i<2; i++)

BvpIntra [xPb][yPb][i]=bvpIntraVirtual[intra_bc_bvp_flag[xPb][yPb][i]

### 8.4.4.2 Derivation Process for Intra Block Copy Block Vector Prediction Candidates

Inputs to this process are:

a luma location (xCb, yCb) of the top-left sample of the current luma coding block relative to the top-left luma sample of the current picture,

a variable nCbS specifying the size of the current luma coding block,

a luma location (xPb, yPb) specifying the top-left sample of the current luma prediction block relative to the top-left luma sample of the current picture,

two variables nPbW and nPbH specifying the width and the height of the luma prediction block,

a variable partIdx specifying the index of the current prediction unit within the current coding unit.

Outputs of this process are (with N being replaced by A or B):

the block vectors bvIntraN of the neighbouring prediction units.

the availability flags availableFlagN of the neighbouring prediction units.

The variables bvIntraA[compIdx] specify the left neighboring block vector predictor with compIdx being 0 or 1. The horizontal block vector component is assigned compIdx=0 and the vertical block vector component is assigned compIdx=1. The variable availableFlagN specifies the availability flags of the left and above neighboring blocks, with N being equal to A or B. bvIntraN[compIdx] and availableFlagN are derived as follows:
bvIntraN[compIdx] is set equal to 0 for compIdx being equal to 0 and 1 and N being equal to A and B;
availableFlagN is set equal to FALSE for N being equal to A and B.
The availability derivation process for a prediction block as specified in subclause 6.4.2 is invoked with the luma location (xCb, yCb), the current luma coding block size nCbS, the luma prediction block location (xPb, yPb), the luma prediction block width nPbW, the luma prediction block height nPbH, the luma location (xPb−1, yPb+nPbH−1), and the partition index partIdx as inputs, if the output is equal to TRUE, then availableFlagA is set to TRUE, and

bvIntraA=bvIntra[xPb−1][yPb+nPbH−1]

The availability derivation process for a prediction block as specified in subclause 6.4.2 is invoked with the luma location (xCb, yCb), the current luma coding block size nCbS, the luma prediction block location (xPb, yPb), the luma prediction block width nPbW, the luma prediction block height nPbH, the luma location (xPb−nPbW−1, yPb−1), and the partition index partIdx as inputs. If the output is equal to TRUE, and (yPb/CtbSizeY) is equal to ((yPb−1)/CtbSizeY), then availableFlagB is set to TRUE, and

bvIntraB=bvIntra[xPb−nPbW−1][yPb−1]

### 8.4.5 Decoding Process for Intra Blocks

### 8.4.5.1 General Decoding Process for Intra Blocks

Inputs to this process are:

a sample location (xTb0, yTb0) specifying the top-left sample of the current transform block relative to the top-left sample of the current picture,

a variable log 2TrafoSize specifying the size of the current transform block,

a variable trafoDepth specifying the hierarchy depth of the current block relative to the coding unit,

a variable predModeIntra specifying the intra prediction mode,

a variable predModeIntraBc specifying the intra block copying mode,

a variable bvIntra specifying the intra block copying vector,

a variable cIdx specifying the colour component of the current block.

Output of this process is a modified reconstructed picture before deblocking filtering.
The luma sample location (xTbY, yTbY) specifying the top-left sample of the current luma transform block relative to the top-left luma sample of the current picture is derived as follows:

(xTbY, yTbY)=(cIdx==0)?(xTb0, yTb0):(xTb0*SubWidthC, yTb0*SubH eightC) (8-26)

The variable splitFlag is derived as follows:

If cIdx is equal to 0, splitFlag is set equal to

split_transform_flag[xTbY][yTbY][trafoDepth].

Otherwise, if all of the following conditions are true, splitFlag is set equal to 1.
cIdx is greater than 0
split_transform_flag[xTbY][yTbY][trafoDepth] is equal to 1
log 2TrafoSize is greater than 2

Otherwise, splitFlag is set equal to 0.

Depending on the value of splitFlag, the following applies:

If splitFlag is equal to 1, the following ordered steps apply:

1. The variables xTb1 and yTb1 are derived as follows:

If either cIdx is equal to 0 or ChromaArrayType is not equal to 2, the following applies:

The variable xTb1 is set equal to xTb0+(1<<(log 2TrafoSize−1)).

The variable yTb1 is set equal to yTb0+(1<<(log 2TrafoSize−1)).

Otherwise (ChromaArrayType is equal to 2 and cIdx is greater than 0), the following applies:

The variable xTb1 is set equal to xTb0+(1<<(log 2TrafoSize−1)).

The variable yTb1 is set equal to yTb0+(2<<(log 2TrafoSize−1)).

2. The general decoding process for intra blocks as specified in this subclause is invoked with the location (xTb0, yTb0), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering.
3. The general decoding process for intra blocks as specified in this subclause is invoked with the location (xTb1, yTb0), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering.
4. The general decoding process for intra blocks as specified in this subclause is invoked with the location (xTb0, yTb1), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering.
5. The general decoding process for intra blocks as specified in this subclause is invoked with the location (xTb1, yTb1), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering.
Otherwise (splitFlag is equal to 0), for the variable blkIdx proceeding over the values 0 . . . (cIdx>0 && ChromaArrayType==2?1:0), the following ordered steps apply:
   1. The variable nTbS is set equal to 1<<log 2TrafoSize.
   2. The variable yTbOffset is set equal to blkIdx*nTbS.
   3. The variable yTbOffsetY is set equal to yTbOffset*SubHeightC.
   4. The variable residualDpcm is derived as follows:

If all of the following conditions are true, residualDpcm is set equal to 1.

implicit_rdpcm_enabled_flag is equal to 1.

either transform_skip_flag[xTbY][yTbY+yTbOffsetY][cIdx] is equal to 1, or cu_transquant_bypass_flag is equal to 1.

either predModeIntra is equal to 10, or predModeIntra is equal to 26.
Otherwise, residualDpcm is set equal to
   explicit_rdpcm_flag[xTbY][yTbY+yTbOffsetY][cIdx].
   5. Depending upon the value of predModeIntraBc, the following applies:

The When predModeIntraBc is equal to 0, the general intra sample prediction process as specified in subclause 8.4.4.2.1 is invoked with the transform block location (xTb0, yTb0+yTbOffset), the intra prediction mode predModeIntra, the transform block size nTbS, and the variable cIdx as inputs, and the output is an (nTbS)×(nTbS) array predSamples.

Otherwise (predModeIntraBc is equal to 1), the intra block copying process as specified in subclause 8.4.5.2.7 is invoked with the transform block location (xTb0, yTb0+yTbOffset), the transform block size nTbS, the variable trafoDepth, the variable bvIntra, and the variable cIdx as inputs, and the output is an (nTbS)×(nTbS) array predSamples.

6. The scaling and transformation process as specified in subclause 8.6.2 is invoked with the luma location (xTbY, yTbY+yTbOffsetY), the variable trafoDepth, the variable cIdx, and the transform size trafoSize set equal to nTbS as inputs, and the output is an (nTbS)×(nTbS) array resSamples.
7. When residualDpcm is equal to 1, depending upon the value of predModeIntraBc, the following applies:

When predModeIntraBc is equal to 0, the directional residual modification process for blocks using a transform bypass as specified in subclause 8.6.5 is invoked with the variable mDir set equal to predModeIntra/26, the variable nTbS, and the (nTbS)×(nTbS) array r set equal to the array resSamples as inputs, and the output is a modified (nTbS)×(nTbS) array resSamples.

Otherwise, (predModeIntraBc is equal to 1), the directional residual modification process for blocks using a transform bypass as specified in subclause 8.6.5 is invoked with the variable mDir set equal to

explicit_rdpcm_dir_flag[xCb+xB0 xTbY][yCb+yB0 yTbY+yTbOffsetY][cIdx],

the variable nTbS, and the (nTbS)×(nTbS) array r set equal to the array resSamples as inputs, and the output is a modified (nTbS)×(nTbS) array resSamples.
8. When cross_component_prediction_enabled_flag is equal to 1, ChromaArrayType is equal to 3, and cIdx is not equal to 0, the residual modification process for transform blocks using cross-component prediction as specified in subclause 8.6.6 is invoked with the current luma transform block location (xTbY, yTbY), the variable nTbS, the variable cIdx, the (nTbS)×(nTbS) array rY set equal to the corresponding luma residual sample array resSamples of the current transform block, and the (nTbS)×(nTbS) array r set equal to the array resSamples as inputs, and the output is a modified (nTbS)×(nTbS) array resSamples.
9. The picture reconstruction process prior to in-loop filtering for a colour component as specified in subclause 8.6.6 is invoked with the transform block location (xTb0, yTb0+yTbOffset), the variables nCurrSw and nCurrSh both set equal to nTbS, the variable cIdx, the (nTbS)×(nTbS) array predSamples, and the (nTbS)×(nTbS) array resSamples as inputs.

### 8.4.5.2.7 Specification of Intra Block Copying Prediction Mode

Inputs to this process are:

a sample location (xTb0Cmp, yTb0Cmp) specifying the top-left sample of the current transform block relative to the top-left sample of the current picture,

a variable nTbS specifying the transform block size,

a variable trafoDepth specifying the hierarchy depth of the current block relative to the coding unit,

a variable bvIntra specifying the block copying vector,

a variable cIdx specifying the colour component of the current block.

Output of this process is the predicted samples predSamples[x][y], with x, y=0 . . . nTbS−1.
The luma sample location (xTbY, yTbY) specifying the top-left sample of the current luma transform block relative to the top-left luma sample of the current picture is derived as follows:

(xTbY, yTbY)=(cIdx==0)?(xTb0, yTb0):(xTb0*SubWidthsC, yTb0*SubH eightC) (8-62)

Depending upon the values of trafoDepth, PartMode and nTbS, the following applies:

If trafoDepth is equal to 0, PartMode is not equal to PART_{—}2N×2N, and nTbS is greater than 4, the following applies, for the variable tempIdx proceeding over the values 0 . . . 3:

The variable nTbS1 is set equal to nTbS/2.

The variable xTb1 is set equal to xTb0+nTbS1*(blkIdx % 2).

The variable yTb1 is set equal to yTb0+nTbS1*(blkIdx/2).

The general intra block copying process as specified in this subclause is invoked with the location (xTb1, yTb1), the variable nTbS set equal to nTbS1, the variable bvIntra, the variable trafoDepth is set equal to 1, and the variable cIdx as inputs, and the output is an (nTbS1)×(nTbS1) array predSamples. [Ed: This should be tempSamples, and then copied into predSamples]
Otherwise, the variable by representing the block vector for prediction in full-sample units is derived as follows:
If cIdx is not equal to 0, trafoDepth is equal to 0, and nTbS is equal to 4, the following applies:
If ChromaArrayType is equal to 1, by is set equal to bvIntra[xTbY+4][yTbY+4].
   The bitstream shall not contain data such that the value of bvIntra[xTbY+4][yTbY+4] is invalid when used as the value of bvIntra[xTbY][yTbY], where validity is defined by the bitstream conformance requirements specified in subclause 8.4.4.
Otherwise, if ChromaArrayType is equal to 2, by is set equal to bvIntra[xTbY+4][yTbY].
   The bitstream shall not contain data such that the value of bvIntra[xTbY+4][yTbY] is invalid when used as the value of bvIntra[xTbY][yTbY], where validity is defined by the bitstream conformance requirements specified in subclause 8.4.4.
Otherwise, the following applies:

bv[0]=bvIntra[xTbY][yTbY][0]>>(((cIdx==0)?1: SubWidthC)−1) (8-6327)

bv[1]=bvIntra[xTbY][yTbY][1]>>(((cIdx==0)?1: SubHeightC)−1) (8-6427)
The (nTbS)×(nTbS) array of predicted samples, with x, y=0 . . . nTbS−1, are is derived as follows:
The reference sample location (xRefCmp, yRefCmp) is specified by:

(xRefCmp, yRefCmp)=(xTbCmp+x+bv[0], yTbCmp+y+bv[1]) (8-6527)

Each sample at the location (xRefCmp, yRefCmp) is assigned to predSamples[x][y].

### Embodiment #2

Similar to embodiment #1, this embodiment shows another example with supporting Intra BC with a block vector candidate list. The current CU may be coded with skip mode and Intra BC mode together, thus the block vector candidate is used to derive the block vector directly. The normal merge mode (non-skip merge) for Intra BC is not supported in this embodiment.

Syntax for Example Embodiment #2 is now described.
Coding unit syntax for Embodiment #2 is described in Syntax Table 2.1 below.

SYNTAX TABLE 2.1

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| if( intra_block_copy_enabled_flag ) { | |
| intra_bc_flag[ x0 ][ y0 ] | ae(v) |
| if( !intra_bc_flag[ x0 ][ y0 ] ) | |
| intra_bc_skip_flag[ x0 ][ y0 ] | ae(v) |
| } | |
| if( slice_type != I && != intra_bc_flag[ x0 ][ y0 ] ) | |
| pred_mode_flag | ae(v) |
| if( CuPredMode[ x0 ][ y0 ] != MODE_INTRA \|\| | |
| (intra_bc_flag[ x0 ][ y0 ] && | |
| !intra_bc_skip_flag[ x0 ][ y0 ] \|\| log2CbSize = = MinCbLog2SizeY ) | |
| part_mode | ae(v) |
| if( CuPredMode[ x0 ][ y0 ] = = MODE_INTRA && ! | |
| intra_bc_flag[ x0 ][ y0 ] ) { | |
| if( PartMode = = PART_2N×2N && pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else { | |
| pbOffset = ( PartMode = = PART_N×N ) ? ( nCbS / 2 ) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] ) \|\| | |
| ( CuPredMode[ x0 ][ y0 ] = = MODE_INTRA && | |
| intra_bc_flag[ x0 ][ y0 ]) | |
| rqt_root_cbf | ae(v) |
| if( rqt_root_cbf ) { | |
| MaxTrafoDepth = ( CuPredMode[ x0 ][ y0 ] = = MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Prediction unit syntax

| prediction_unit( x0, y0, nPbW, nPbH ) { | Descriptor |
|---|---|
| if( cu_skip_flag[ x0 ][ y0 ] \|\| intra_bc_skip_flag[ x0 ][ y0 ] ) { | |
| if (! intra_bc_flag[ x0 ][ y0 ]) { | |
| if( MaxNumMergeCand > 1 ) | |
| merge_idx[ x0 ][ y0 ] | ae(v) |
| } | |
| else | |
| intra_bc_merge_idx[ x0 ][ y0 ] | ae(v) |
| } else if (intra_bc_flag[ x0 ][ y0 ]){ /* Intra BC*/ | |
| mvd_coding( x0, y0, 2) | |
| intra_bc_bvp_flag[ x0 ][ y0 ] | ae(v) |
| } else {/* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

Semantics for Embodiment #2 are now described.
SPS Semantics for Embodiment #2 are as follows:

intra_block_copy_enabled_flag equal to 1 specifies that intra block copy may be invoked in the decoding process for intra prediction.

intra_block_copy_enabled_flag equal to 0 specifies that intra block copy is not applied. When not present, the value of intra_block_copy_enabled_flag is inferred to be equal to 0.
Coding Unit Semantics for Embodiment #2 are as follows:

intra_bc_flag[x0][y0] equal to 1 specifies that the current coding unit is coded in intra block copy mode. intra_bc_flag[x0][y0] equal to 0 specifies that the current coding unit is coded according to pred_mode_flag. When not present, the value of intra_bc_flag is inferred to be equal to 1 if slice type is equal to I and cu_skip_flag is equal to 1, otherwise the value of intra_bc_flag is inferred to be equal to 0. The array indices x0, y0 specify the location (x0, y0) of the top-left luma sample of the considered coding block relative to the top-left luma sample of the picture.

intra_bc_skip_flag[x0][y0] equal to 1 specifies that the current coding unit is coded in skipped intra block copy mode (intra block copy with PartMode equaling to PART_{—}2N×2N and without any residue). intra_bc_skip_flag[x0][y0] equal to 0 specifies that the current coding unit is not coded in skipped intra block copy mode. When not present, the value of intra_bc_skip_flag is inferred to be equal to 0. The array indices x0, y0 specify the location (x0, y0) of the top-left luma sample of the considered coding block relative to the top-left luma sample of the picture.

pred_mode_flag equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1:

If pred_mode_flag is equal to 0, CuPredMode[x][y] is set equal to MODE_INTER.

Otherwise (pred_mode_flag is equal to 1), CuPredMode[x][y] is set equal to MODE_INTRA.

When pred_mode_flag is not present, the variable CuPredMode[x][y] is derived as follows for x=x0 . . . x0+nCbS−1 and y=y0 . . . y0+nCbS−1:

If intra_bc_flag[x0][y0] is equal to 1, CuPredMode[x][y] is inferred to be equal to MODE_INTRA.

Otherwise, if slice_type is equal to I, CuPredMode[x][y] is inferred to be equal to MODE_INTRA.

Otherwise (slice_type is equal to P or B), when cu_skip_flag[x0][y0] is equal to 1, CuPredMode[x][y] is inferred to be equal to MODE_SKIP.

part_mode specifies partitioning mode of the current coding unit. The semantics of part_mode depend on CuPredMode[x0][y0]. The variables PartMode and IntraSplitFlag are derived from the value of part_mode as defined in Table 7-10.

The value of part_mode is restricted as follows:

If CuPredMode[x0][y0] is equal to MODE_INTRA, the following applies:

If intra_bc_flag[x0][y0] is equal to 1, part_mode shall be in the range of 0 to 3, inclusive.

Otherwise (intra_bc_flag[x0][y0] is equal to 0), part_mode shall be equal to 0 or 1.

Otherwise (CuPredMode[x0][y0] is equal to MODE_INTER), the following applies:

If log 2CbSize is greater than MinCbLog2SizeY and amp_enabled_flag is equal to 1, part_mode shall be in the range of 0 to 2, inclusive, or in the range of 4 to 7, inclusive.

Otherwise, if log 2CbSize is greater than MinCbLog2SizeY and amp_enabled_flag is equal to 0, or log 2CbSize is equal to 3, part_mode shall be in the range of 0 to 2, inclusive.

Otherwise (log 2CbSize is greater than 3 and less than or equal to MinCbLog2SizeY), the value of part_mode shall be in the range of 0 to 3, inclusive.

When part_mode is not present, the variables PartMode and IntraSplitFlag are derived as follows:

PartMode is set equal to PART_{—}2N×2N.

IntraSplitFlag is set equal to 0.

Prediction Unit Semantics for Embodiment #2 are now described

intra_bc_merge_idx [x0][y0] specifies the merging candidate index of the merging candidate list for intra block copy where x0, y0 specify the location (x0, y0) of the top-left luma sample of the considered prediction block relative to the top-left luma sample of the picture.

When merge_idx[x0][y0] is not present, it is inferred to be equal to 0.

intra_bc_bvp_flag [x0][y0] specifies the block vector predictor index of the predictor candidate list where x0, y0 specify the location (x0, y0) of the top-left luma sample of the considered prediction block relative to the top-left luma sample of the picture.

When intra_bc_bvp_flag[x0][y0] is not present, it is inferred to be equal to 0.

### Embodiment #3

Similar to embodiment #1, however, this embodiment shows an example with supporting Intra BC with a block vector candidate list. The current CU may be coded with merge mode and Intra BC mode together, thus the block vector candidate is used to derive the block vector directly. The skip mode for Intra BC is not supported in this embodiment.

Syntax for Embodiment #3 is now described
Coding unit syntax for Embodiment #3 is described in Syntax Table 3.1 below.

SYNTAX TABLE 3.1

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| if( intra_block_copy_enabled_flag ) | |
| intra_bc_flag[ x0 ][ y0 ] | ae(v) |
| if( slice_type != I && != intra_bc_flag[ x0 ][ y0 ] ) | |
| pred_mode_flag | ae(v) |
| if( CuPredMode[ x0 ][ y0 ] != MODE_INTRA \|\| | |
| intra_bc_flag[ x0 ][ y0 ] \|\| log2CbSize = = MinCbLog2SizeY ) | |
| part_mode | ae(v) |
| if( CuPredMode[ x0 ][ y0 ] = = MODE_INTRA && ! | |
| intra_bc_flag[ x0 ][ y0 ] ) { | |
| if( PartMode = = PART_2N×2N && pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else { | |
| pbOffset = ( PartMode = = PART_N×N ) ? ( nCbS / 2) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( (CuPredMode[ x0 ][ y0 ] != MODE_INTRA ) && | |
| !( PartMode = = PART_2N×2N && merge_flag[ x0 ][ y0 ] ) \|\| | |
| ( CuPredMode[ x0 ][ y0 ] = = MODE_INTRA && | |
| intra_bc_flag[ x0 ][ y0 ]) | |
| rqt_root_cbf | ae(v) |
| if( rqt_root_cbf ) { | |
| MaxTrafoDepth = ( CuPredMode[ x0 ][ y0 ] = = MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Prediction unit syntax for Embodiment #3 is described in Syntax 3.2 below.

SYNTAX TABLE 3.3

| prediction_unit( x0, y0, nPbW, nPbH ) { | Descriptor |
|---|---|
| if( cu_skip_flag[ x0 ][ y0 ]) { | |
| if( MaxNumMergeCand > 1 ) | |
| merge_idx[ x0 ][ y0 ] | ae(v) |
| } | |
| } else {/* MODE_INTER or Intra BC merge*/ | |
| merge_flag[ x0 ][ y0 ] | ae(v) |
| if( merge_flag[ x0 ][ y0 ] ) { | |
| if(!intra_bc_flag[ x0 ][ y0 ]){ | |
| if( MaxNumMergeCand > 1 ) | |
| merge_idx[ x0 ][ y0 ] | ae(v) |
| }else | |
| intra_bc_merge_idx[ x0 ][ y0 ] | |
| } else if (intra_bc_flag[ x0 ][ y0 ]){ /* Intra BC*/ | |
| mvd_coding( x0, y0, 2) | |
| intra_bc_bvp_flag[ x0 ][ y0 ] | ae(v) |
| } else { /* MODE_INTER */ | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

Semantics for Embodiment #3 are now described.
Coding Unit Semantics for Embodiment #3 are as follows:

intra_bc_flag[x0][y0] equal to 1 specifies that the current coding unit is coded in intra block copy mode. intra_bc_flag[x0][y0] equal to 0 specifies that the current coding unit is coded according to pred_mode_flag. When not present, the value of intra_bc_flag is inferred to be equal to 1 if slice type is equal to I and cu_skip_flag is equal to 1, otherwise the value of intra_bc_flag is inferred to be equal to 0. The array indices x0, y0 specify the location (x0, y0) of the top-left luma sample of the considered coding block relative to the top-left luma sample of the picture.

pred_mode_flag equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1:

If pred_mode_flag is equal to 0, CuPredMode[x][y] is set equal to MODE_INTER.

Otherwise (pred_mode_flag is equal to 1), CuPredMode[x][y] is set equal to MODE_INTRA.

When pred_mode_flag is not present, the variable CuPredMode[x][y] is derived as follows for x=x0 . . . x0+nCbS−1 and y=y0 . . . y0+nCbS−1:

If intra_bc_flag[x0][y0] is equal to 1, CuPredMode[x][y] is inferred to be equal to MODE_INTRA.

Otherwise, if slice_type is equal to I, CuPredMode[x][y] is inferred to be equal to MODE_INTRA.

Otherwise (slice_type is equal to P or B), when cu_skip_flag[x0][y0] is equal to 1, CuPredMode[x][y] is inferred to be equal to MODE_SKIP.

part_mode specifies partitioning mode of the current coding unit. The semantics of part_mode depend on CuPredMode[x0][y0]. The variables PartMode and IntraSplitFlag are derived from the value of part_mode as defined in Table 7-10.

The value of part_mode is restricted as follows:

If CuPredMode[x0][y0] is equal to MODE_INTRA, the following applies:

If intra_bc_flag[x0][y0] is equal to 1, part_mode shall be in the range of 0 to 3, inclusive.

Otherwise (intra_bc_flag[x0][y0] is equal to 0), part_mode shall be equal to 0 or 1.

Otherwise (CuPredMode[x0][y0] is equal to MODE_INTER), the following applies:

If log 2CbSize is greater than MinCbLog2SizeY and amp_enabled_flag is equal to 1, part_mode shall be in the range of 0 to 2, inclusive, or in the range of 4 to 7, inclusive.

Otherwise, if log 2CbSize is greater than MinCbLog2SizeY and amp_enabled_flag is equal to 0, or log 2CbSize is equal to 3, part_mode shall be in the range of 0 to 2, inclusive.

Otherwise (log 2CbSize is greater than 3 and less than or equal to MinCbLog2SizeY), the value of part_mode shall be in the range of 0 to 3, inclusive.

When part_mode is not present, the variables PartMode and IntraSplitFlag are derived as follows:

PartMode is set equal to PART_{—}2N×2N.

IntraSplitFlag is set equal to 0.

Prediction Unit Semantics for Embodiment #3 are as follows:

intra_bc_merge_idx [x0][y0] specifies the merging candidate index of the merging candidate list for intra block copy where x0, y0 specify the location (x0, y0) of the top-left luma sample of the considered prediction block relative to the top-left luma sample of the picture.

When merge_idx[x0][y0] is not present, it is inferred to be equal to 0.

intra_bc_bvp_flag[x0][y0] specifies the block vector predictor index of the predictor candidate list where x0, y0 specify the location (x0, y0) of the top-left luma sample of the considered prediction block relative to the top-left luma sample of the picture.

When intra_bc_bvp_flag[x0][y0] is not present, it is inferred to be equal to 0.

### Embodiment #4

Similar to embodiment #3, however, the intra_bc_bvp_flag is present in the coding unit syntax structure.

Syntax for Embodiment #4 is described in the syntax tables below.
Coding unit syntax for Embodiment #4 is described in Syntax Table 4.1 below.

SYNTAX TABLE 4.1

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| [symbol] | |
| [symbol] | [symbol] |
| if(!intra_bc_flag[x0][y0]){ | |
| if( slice_type != I [symbol] | |
| pred_mode_flag | ae(v) |
| if( CuPredMode[ x0 ][ y0 ] != MODE_INTRA \|\| | |
| [symbol] \|\| | |
| log2CbSize = = MinCbLog2SizeY ) | |
| part_mode | ae(v) |
| [symbol] | |
| if( CuPredMode[ x0 ][ y0 ] = = MODE_INTRA ) { | |
| if( PartMode = = PART_2N×2N && pcm_enabled_flag && | |
| [symbol] && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| [symbol] | |
| [symbol] | |
| intra_bc_bvp_flag[ x0 ][ y0 ] | ae(v) |
| [symbol] | |
| [symbol] | |
| intra_bc_bvp_flag[ x0 ][ y0 + ( nCbS / 2 )] | ae(v) |
| [symbol] | |
| [symbol] | |
| intra_bc_bvp_flag[ x0 + ( nCbS / 2 )][ y0 ] | ae(v) |
| [symbol] | |
| [symbol] | |
| intra_bc_bvp_flag[ x0 + ( nCbS / 2 )][ y0 ] | ae(v) |
| [symbol] | |
| intra_bc_bvp_flag[ x0 ][ y0 + ( nCbS / 2 )] | ae(v) |
| [symbol] | |
| intra_bc_bvp_flag[ x0 + ( nCbS / 2 ][ y0 + ( nCbS / 2 )] | ae(v) |
| [symbol] | |
| } else { | |
| pbOffset = ( PartMode = = PART_N×N ) ? ( nCbS / 2 ) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] ) \|\| | |
| [symbol] | |
| [symbol] | |
| rqt_root_cbf | ae(v) |
| if( rqt_root_cbf ) { | |
| MaxTrafoDepth = ( CuPredMode[ x0 ][ y0 ] = = | |
| MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Semantics for Embodiment #4 are described below.
Coding unit semantics for Embodiment #4 are as follows:
intra_bc_bvp_flag[x0][y0] specifies the block vector predictor index of the predictor candidate list where x0, y0 specify the location (x0, y0) of the top-left luma sample of the considered prediction block relative to the top-left luma sample of the picture.
When intra_bc_bvp_flag[x0][y0] is not present, it is inferred to be equal to 0.

### Embodiment #5

Similar to embodiment #1 and embodiment #3, however, the block vector prediction is designed to reuse the AMVP process. Note that in this case the current picture used for Intra BC is marked as long-term and considered to be inserted as the last entry in reference picture list 0 for Inter slices and the only entry in reference picture list 0 for Intra slices.

### Decoding Process

### 8.4.4.1 Derivation Process for Intra Block Copy Block Vector Prediction Candidates

Inputs to this process are:

a luma location (xCb, yCb) of the top-left sample of the current luma coding block relative to the top-left luma sample of the current picture,

a variable nCbS specifying the size of the current luma coding block,

a luma location (xPb, yPb) specifying the top-left sample of the current luma prediction block relative to the top-left luma sample of the current picture,

two variables nPbW and nPbH specifying the width and the height of the luma prediction block,

the reference index of the current prediction unit partition refIdxL2

a variable partIdx specifying the index of the current prediction unit within the current coding unit.

Output of this process is the block vector prediction BvpIntra[xPb][yPb].
The motion vector predictor BvpIntra is derived in the following ordered steps:
1. The derivation process for motion vector predictor candidates from neighbouring prediction unit partitions in subclause 8.5.3.2.6 is invoked with the luma coding block location (xCb, yCb), the coding block size nCbS, the luma prediction block location (xPb, yPb), the luma prediction block width nPbW, the luma prediction block height nPbH, refIdxLX, with X being 0, and the partition index partIdx as inputs, and the availability flags availableFlagLXN and the block vectors bvIntraN, with N being replaced by A or B, as output.
2. The variables bvpIntraVirtual[i] (with i being equal to 0 or 1) specify two virtual block vector predictors, and they are derived as follows:

bvpIntraVirtual[0][0]=−2*nPbW, bvpIntraVirtual[0][1]=0;

bvpIntraVirtual[1][0]=2*nPbW, bvpIntraVirtual1[0][1]=0;

3. The block vector predictor candidate list, bvpIntraList, is constructed as follows:

```
i = 0
if(availableFlagA )
      bvpIntraList[ i++ ] = bvIntraA
if(availableFlagB && bvIntraA!= bvIntraB)
      bvpIntraList[ i++ ] = bvIntraB
for( j=0; j<2 && i<2;j++) {
      if( (j = =1 || bvpIntraList[ 0 ]!= bvpIntraVirtual[ j ] )
                        bvpIntraList[ i++ ]= bvpIntraVirtual[ j ]
}
```

4. The block vector bvIntra[xPb][yPb] is derived as follows.
for (i=0; i<2; i++)

bvIntra[xPb][yPb][i]=bvpIntraVirtual[intra_bc_bvp_flag[xPb][yPb][i]+BvpIntra [i]

### 8.5.3.2.6 Derivation Process for Motion Vector Predictor Candidates

Inputs to this process are:

a luma location (xCb, yCb) of the top-left sample of the current luma coding block relative to the top-left luma sample of the current picture,

a variable nCbS specifying the size of the current luma coding block,

a luma location (xPb, yPb) specifying the top-left sample of the current luma prediction block relative to the top-left luma sample of the current picture,

two variables nPbW and nPbH specifying the width and the height of the luma prediction block,

the reference index of the current prediction unit partition refIdxLX, with X being 0 or 1.

a variable partIdx specifying the index of the current prediction unit within the current coding unit.

Outputs of this process are (with N being replaced by A or B):

the motion vectors mvLXN of the neighbouring prediction units.

the availability flags availableFlagLXN of the neighbouring prediction units.

If intra_bc_flag[xPb][yPb] is equal to 1, availableA₀, availableB₀ and availableB₂ are set equal to FALSE.
The variable currPb specifies the current luma prediction block at luma location (xPb, yPb) and the variable currPic specifies the current picture.
The variable is ScaledFlagLX, with X being 0 or 1, is set equal to 0.
The motion vector mvLXA and the availability flag availableFlagLXA are derived in the following ordered steps:
. . . (no change)
Alternatively, the above added highlighted text can be done in a different sub-clause and invoked right before the current sub-clause 8.5.3.2.6 is invoked.
Alternatively, in addition, the following applies right before the current sub-clause 8.5.3.2.6 is invoked.
If intra_bc_flag[xPb] [yPb] is equal to 1, avaTempA₀ is set equal to availableA₀, avaTempB₀ is set equal to availableB₀ avaTempB₂ is set equal availableB₂ and availableA₀ availableB₀ and availableB₂ are set equal to FALSE.
After this sub-clause is invoked (or at the end of this sub-clause), the following applies:
If intra_bc_flag[xPb][yPb] is equal to 1, availableA₀ is set equal to avaTempA₀, availableB₀ is set equal to avaTempB₀ and availableB₂ set equal avaTempB₂.

### Embodiment #6

Similar to embodiment #5, in addition, default vectors may be used as part of virtual candidate generation process. When Intra BC with merge mode is enabled, the block vector prediction is designed to reuse the HEVC merge process to get the spatial candidates with certain assumptions similar as in embodiment #5. If the number of merge candidates are not enough, instead of generating “zero motion vector merging candidates” as specified in subclause 8.5.3.2.5 in HEVC version 1, the default block vectors e.g., the ones described in invention bullet 2 or the default block vectors as in embodiment #1 are used to fill in the empty entries in the candidate list.

### Embodiment #7

Similar to embodiment #1 or embodiment #5, however, this embodiment shows an example with supporting Intra BC with a block vector candidate list. The skip mode and merge mode for Intra BC are not supported in this embodiment.

Syntax for this Embodiment is now described.
Coding unit syntax is shown in Syntax Table 7.1

SYNTAX TABLE 7.1

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| if( intra_block_copy_enabled_flag ) | |
| intra_bc_flag[ x0 ][ y0 ] | ae(v) |
| if( slice_type != I && != intra_bc_flag[ x0 ][ y0 ] ) | |
| pred_mode_flag | ae(v) |
| if( CuPredMode[ x0 ][ y0 ] != MODE_INTRA \|\| | |
| intra_bc_flag[ x0 ][ y0 ] \|\| log2CbSize = = MinCbLog2SizeY ) | |
| part_mode | ae(v) |
| if( CuPredMode[ x0 ][ y0 ] = = MODE_INTRA && ! | |
| intra_bc_flag[ x0 ][ y0 ] ) { | |
| if( PartMode = = PART_2N×2N && pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else { | |
| pbOffset = ( PartMode = = PART_N×N ) ? ( nCbS / 2 ) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] \|\| | |
| [symbol] | |
| [symbol] | |
| rqt_root_cbf | ae(v) |
| if( rqt_root_cbf ) { | |
| MaxTrafoDepth = ( CuPredMode[ x0 ][ y0 ] = = MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Prediction unit syntax for this embodiment is shown in Syntax Table 7.2 below

SYNTAX TABLE 7.2

| prediction_unit( x0, y0, nPbW, nPbH ) { | Descriptor |
|---|---|
| if( cu_skip_flag[ x0 ][ y0 ]) { | |
| if( MaxNumMergeCand > 1 ) | |
| merge_idx[ x0 ][ y0 ] | ae(v) |
| } else if (intra_bc_flag[ x0 ][ y0 ]){ /* Intra BC*/ | |
| mvd_coding( x0, y0, 2) | |
| intra_bc_bvp_flag[ x0 ][ y0 ] | ae(v) |
| } else { /* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

### Semantics

Coding Unit Semantics for this Embodiment are as follows:

intra_bc_flag[x0][y0] equal to 1 specifies that the current coding unit is coded in intra block copy mode. intra_bc_flag[x0][y0] equal to 0 specifies that the current coding unit is coded according to pred_mode_flag. When not present, the value of intra_bc_flag is inferred to be equal to 0. The array indices x0, y0 specify the location (x0, y0) of the top-left luma sample of the considered coding block relative to the top-left luma sample of the picture.

pred_mode_flag equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1:

If pred_mode_flag is equal to 0, CuPredMode[x][y] is set equal to MODE_INTER.

Otherwise (pred_mode_flag is equal to 1), CuPredMode[x][y] is set equal to MODE_INTRA.

When pred_mode_flag is not present, the variable CuPredMode[x][y] is derived as follows for x=x0 . . . x0+nCbS−1 and y=y0 . . . y0+nCbS−1:

If intra_bc_flag[x0][y0] is equal to 1, CuPredMode[x][y] is inferred to be equal to MODE_INTRA.

Otherwise, if slice_type is equal to I, CuPredMode[x][y] is inferred to be equal to MODE_INTRA.

Otherwise (slice_type is equal to P or B), when cu_skip_flag[x0][y0] is equal to 1, CuPredMode[x][y] is inferred to be equal to MODE_SKIP.

part_mode specifies partitioning mode of the current coding unit. The semantics of part_mode depend on CuPredMode[x0][y0]. The variables PartMode and IntraSplitFlag are derived from the value of part_mode as defined in Table 7-10.

The value of part_mode is restricted as follows:

If CuPredMode[x0][y0] is equal to MODE_INTRA, the following applies:

If intra_bc_flag[x0][y0] is equal to 1, part_mode shall be in the range of 0 to 3, inclusive.

Otherwise (intra_bc_flag[x0][y0] is equal to 0), part_mode shall be equal to 0 or 1.

Otherwise (CuPredMode[x0][y0] is equal to MODE_INTER), the following applies:

If log 2CbSize is greater than MinCbLog2SizeY and amp_enabled_flag is equal to 1, part_mode shall be in the range of 0 to 2, inclusive, or in the range of 4 to 7, inclusive.

Otherwise, if log 2CbSize is greater than MinCbLog2SizeY and amp_enabled_flag is equal to 0, or log 2CbSize is equal to 3, part_mode shall be in the range of 0 to 2, inclusive.

Otherwise (log 2CbSize is greater than 3 and less than or equal to MinCbLog2SizeY), the value of part_mode shall be in the range of 0 to 3, inclusive.

When part_mode is not present, the variables PartMode and IntraSplitFlag are derived as follows:

PartMode is set equal to PART_{—}2N×2N.

IntraSplitFlag is set equal to 0.

Prediction Unit Semantics for this embodiment are as follows:
intra_bc_bvp_flag[x0][y0] specifies the block vector predictor index of the predictor candidate list where x0, y0 specify the location (x0, y0) of the top-left luma sample of the considered prediction block relative to the top-left luma sample of the picture.
When intra_bc_bvp_flag[x0][y0] is not present, it is inferred to be equal to 0.

### Embodiment #8

Similar to embodiment #3, the current block (CU or PU) may be coded with merge mode and Intra BC mode together. The skip mode for Intra BC is not supported in this embodiment.

Note that in this embodiment, the Intra BC merge and HEVC merge share the same syntax elements merge_idx. The candidate list for merge mode is shared between Intra BC merge and HEVC merge, and it may include both inter and Intra BC candidates. Whether the current block is Intra BC merge or HEVC merge depends on the mode of the candidate indicated by merge_idx. In this case, the number of possible values of merge_idx for Inter or Intra slice may be different, e.g., 2.

Syntax for this embodiment are now described

Coding unit syntax for this embodiment are described in syntax table 8.1 below.

SYNTAX TABLE 8.1

| coding_unit( x0, y0, log2CbSize ) { | Descriptor |
|---|---|
| if( transquant_bypass_enabled_flag ) | |
| cu_transquant_bypass_flag | ae(v) |
| if( slice type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| if( intra_block_copy_enabled_flag ) | |
| intra_bc_flag[ x0 ][ y0 ] | ae(v) |
| if( slice_type != I && != intra_bc_flag[ x0 ][ y0 ] ) | |
| pred_mode_flag | ae(v) |
| if( CuPredMode[ x0 ][ y0 ] != MODE_INTRA \|\| | |
| intra_bc_flag[ x0 ][ y0 ] \|\| log2CbSize = = MinCbLog2SizeY ) | |
| part_mode | ae(v) |
| if( CuPredMode[ x0 ][ y0 ] = = MODE_INTRA && ! | |
| intra_bc_flag[ x0 ][ y0 ] ) { | |
| if( PartMode = = PART_2N×2N && pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else { | |
| pbOffset = ( PartMode = = PART_N×N ) ? ( nCbS / 2) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] \|\| | |
| [symbol] | |
| [symbol] | |
| rqt_root_cbf | ae(v) |
| if( rqt_root_cbf ) { | |
| MaxTrafoDepth = ( CuPredMode[ x0 ][ y0 ] = = MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Prediction unit syntax for this embodiment are described in syntax table 8.2 below.

SYNTAX TABLE 8.2

| prediction_unit( x0, y0, nPbW, nPbH ) { | Descriptor |
|---|---|
| if( cu_skip_flag[ x0 ][ y0 ]) { | |
| if( MaxNumMergeCand > 1 ) | |
| merge_idx[ x0 ][ y0 ] | ae(v) |
| } | |
| } else {/* MODE_INTER or Intra BC merge*/ | |
| 1 merge_flag[ x0 ][ y0 ] | ae(v) |
| 3 if( merge_flag[ x0 ][ y0 ] ) { | |
| if( MaxNumMergeCand > 1 ) | |
| 5 merge_idx[ x0 ][ y0 ] | ae(v) |
| } else if (intra_bc_flag[ x0 ][ y0 ]){ /* Intra | |
| BC*/ | |
| 8 mvd_coding( x0, y0, 2) | |
| intra_bc_bvp_flag[ x0 ][ y0 ] | ae(v) |
| } else { /* MODE_INTER */ | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

Semantics for this embodiment are now described
Coding Unit Semantics for this embodiment are as follows:

intra_bc_flag[x0][y0] equal to 1 specifies that the current coding unit is coded in intra block copy mode. intra_bc_flag[x0][y0] equal to 0 specifies that the current coding unit is coded according to pred_mode_flag. When not present, the value of intra_bc_flag is inferred to be equal to 0. The array indices x0, y0 specify the location (x0, y0) of the top-left luma sample of the considered coding block relative to the top-left luma sample of the picture.

pred_mode_flag equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1:
If pred_mode_flag is equal to 0, CuPredMode[x][y] is set equal to MODE_INTER.
Otherwise (pred_mode_flag is equal to 1), CuPredMode[x][y] is set equal to MODE_INTRA.

When pred_mode_flag is not present, the variable CuPredMode[x][y] is derived as follows for x=x0 . . . x0+nCbS−1 and y=y0 . . . y0+nCbS−1:
If intra_bc_flag[x0][y0] is equal to 1, CuPredMode[x][y] is inferred to be equal to MODE_INTRA.
Otherwise, if slice_type is equal to I, CuPredMode[x][y] is inferred to be equal to MODE_INTRA.
Otherwise (slice_type is equal to P or B), when cu_skip_flag[x0][y0] is equal to 1,

CuPredMode[x][y] is inferred to be equal to MODE_SKIP.

part_mode specifies partitioning mode of the current coding unit. The semantics of part_mode depend on CuPredMode[x0][y0]. The variables PartMode and IntraSplitFlag are derived from the value of part_mode as defined in Table 7-10.

The value of part_mode is restricted as follows:
If CuPredMode[x0][y0] is equal to MODE_INTRA, the following applies:
If intra_bc_flag[x0][y0] is equal to 1, part_mode shall be in the range of 0 to 3, inclusive.
Otherwise (intra_bc_flag[x0][y0] is equal to 0), part_mode shall be equal to 0 or 1.
Otherwise (CuPredMode[x0][y0] is equal to MODE_INTER), the following applies:
   If log 2CbSize is greater than MinCbLog2SizeY and amp_enabled_flag is equal to 1, part_mode shall be in the range of 0 to 2, inclusive, or in the range of 4 to 7, inclusive.
   Otherwise, if log 2CbSize is greater than MinCbLog2SizeY and amp_enabled_flag is equal to 0, or log 2CbSize is equal to 3, part_mode shall be in the range of 0 to 2, inclusive.
   Otherwise (log 2CbSize is greater than 3 and less than or equal to MinCbLog2SizeY), the value of part_mode shall be in the range of 0 to 3, inclusive.
   When part_mode is not present, the variables PartMode and IntraSplitFlag are derived as follows:
PartMode is set equal to PART_{—}2N×2N.
IntraSplitFlag is set equal to 0.
   Prediction Unit Semantics for this embodiment are as follows:
      intra_bc_bvp_flag[x0][y0] specifies the block vector predictor index of the predictor candidate list where x0, y0 specify the location (x0, y0) of the top-left luma sample of the considered prediction block relative to the top-left luma sample of the picture.
         When intra_bc_bvp_flag[x0][y0] is not present, it is inferred to be equal to 0. In case of merge mode (when merge_flag is equal to 1), intra_bc_flag may be not present even when the current block is coded with Intra BC.

### Embodiment #9

This embodiment #9 is similar to embodiment #8; however, the intra_bc_bvp_flag and mvp_{—}10_flag share the same syntax element.

Syntax for Embodiment #9 are shown in the syntax tables below
Coding unit syntax for Embodiment #9 are shown in Syntax Table 9.1 below

SYNTAX TABLE 9.1

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| if( intra_block_copy_enabled_flag ) | |
| intra_bc_flag[ x0 ][ y0 ] | ae(v) |
| if( slice_type != I && != intra_bc_flag[ x0 ][ y0 ] ) | |
| pred_mode_flag | ae(v) |
| if( CuPredMode[ x0 ][ y0 ] != MODE_INTRA \|\| | |
| intra_bc_flag[ x0 ][ y0 ] \|\| log2CbSize = = MinCbLog2SizeY ) | |
| part_mode | ae(v) |
| if( CuPredMode[ x0 ][ y0 ] = = MODE_INTRA && ! | |
| intra_bc_flag[ x0 ][ y0 ] ) { | |
| if( PartMode = = PART_2N×2N && pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else { | |
| pbOffset = ( PartMode = = PART_N×N ) ? ( nCbS / 2 ) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] \|\| | |
| [symbol] | |
| [symbol] | |
| rqt_root_cbf | ae(v) |
| if( rqt_root_cbf ) { | |
| MaxTrafoDepth = ( CuPredMode[ x0 ][ y0 ] = = MODE_INTRA | |
| ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Prediction unit syntax are shown in Syntax Table 9.2 below

SYNTAX TABLE 9.2

| prediction_unit( x0, y0, nPbW, nPbH ) { | Descriptor |
|---|---|
| if( cu_skip_flag[ x0 ][ y0 ]) { | |
| if( MaxNumMergeCand > 1 ) | |
| merge_idx[ x0 ][ y0 ] | ae(v) |
| } | |
| } else {/* MODE_INTER or Intra BC merge*/ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else if (intra_bc_flag[ x0 ][ y0 ]){ /* Intra BC*/ | |
| mvd_coding( x0, y0, 2) | |
| mvp_l0_flag [ x0 ][ y0 ] | ae(v) |
| } else { /* MODE_INTER */ | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

Semantics for Embodiment #9 are described below.
Coding Unit Semantics for Embodiment #9 are as follows:

intra_bc_flag[x0][y0] equal to 1 specifies that the current coding unit is coded in intra block copy mode. intra_bc_flag[x0][y0] equal to 0 specifies that the current coding unit is coded according to pred_mode_flag. When not present, the value of intra_bc_flag is inferred to be equal to 0. The array indices x0, y0 specify the location (x0, y0) of the top-left luma sample of the considered coding block relative to the top-left luma sample of the picture.

pred_mode_flag equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1:
If pred_mode_flag is equal to 0, CuPredMode[x][y] is set equal to MODE_INTER.
Otherwise (pred_mode_flag is equal to 1), CuPredMode[x][y] is set equal to MODE_INTRA.

When pred_mode_flag is not present, the variable CuPredMode[x][y] is derived as follows for x=x0 . . . x0+nCbS−1 and y=y0 . . . y0+nCbS−1:
If intra_bc_flag[x0][y0] is equal to 1, CuPredMode[x][y] is inferred to be equal to MODE_INTRA.
Otherwise, if slice_type is equal to I, CuPredMode[x][y] is inferred to be equal to MODE_INTRA.
Otherwise (slice_type is equal to P or B), when cu_skip_flag[x0][y0] is equal to 1, CuPredMode[x][y] is inferred to be equal to MODE_SKIP.

part_mode specifies partitioning mode of the current coding unit. The semantics of part_mode depend on CuPredMode[x0][y0]. The variables PartMode and IntraSplitFlag are derived from the value of part_mode as defined in Table 7-10.

The value of part_mode is restricted as follows:
If CuPredMode[x0][y0] is equal to MODE_INTRA, the following applies:
If intra_bc_flag[x0][y0] is equal to 1, part_mode shall be in the range of 0 to 3, inclusive.
Otherwise (intra_bc_flag[x0][y0] is equal to 0), part_mode shall be equal to 0 or 1.
Otherwise (CuPredMode[x0][y0] is equal to MODE_INTER), the following applies:
   If log 2CbSize is greater than MinCbLog2SizeY and amp_enabled_flag is equal to 1, part_mode shall be in the range of 0 to 2, inclusive, or in the range of 4 to 7, inclusive.
   Otherwise, if log 2CbSize is greater than MinCbLog2SizeY and amp_enabled_flag is equal to 0, or log 2CbSize is equal to 3, part_mode shall be in the range of 0 to 2, inclusive.
   Otherwise (log 2CbSize is greater than 3 and less than or equal to MinCbLog2SizeY), the value of part_mode shall be in the range of 0 to 3, inclusive.
   When part_mode is not present, the variables PartMode and IntraSplitFlag are derived as follows:
PartMode is set equal to PART_{—}2N×2N.
IntraSplitFlag is set equal to 0.
   Prediction Unit Semantics for Embodiment #9 are as follows:
      intra_bc_bvp_flag[x0][y0] specifies the block vector predictor index of the predictor candidate list where x0, y0 specify the location (x0, y0) of the top-left luma sample of the considered prediction block relative to the top-left luma sample of the picture. When intra_bc_bvp_flag[x0][y0] is not present, it is inferred to be equal to 0.

### Embodiment #10

Embodiment #10 is an example that supports Intra BC with a block vector candidate list. The number of Intra BC AMVP hypothesis (candidates) is signalled in slice header. The skip mode and merge mode for Intra BC are not supported in this example; however, this is not a requirement of embodiment #10.

Syntax for Embodiment #10 are described below
General slice segment header syntax for Embodiment #10 are shown in Syntax Table 10.1 below

SYNTAX TABLE 10.1

| slice_segment_header( ) { | Descriptor |
|---|---|
| first_slice_segment_in_pic_flag | u(1) |
| if( nal_unit_type >= BLA_W_LP && nal_unit_type <= | |
| RSV_IRAP_VCL23 ) | |
| no_output_of_prior_pics_flag | u(1) |
| slice_pic_parameter_set_id | ue(v) |
| if( !first_slice_segment_in_pic_flag ) { | |
| if( dependent_slice_segments_enabled_flag ) | |
| dependent_slice_segment_flag | u(1) |
| slice_segment_address | u(v) |
| } | |
| if( !dependent_slice_segment_flag ) { | |
| for( i = 0; i < num_extra_slice_header_bits; i++ ) | |
| slice_reserved_flag[ i ] | u(1) |
| slice_type | ue(v) |
| if( output_flag_present_flag ) | |
| pic_output_flag | u(1) |
| if( separate_colour_plane_flag = = 1 ) | |
| colour_plane_id | u(2) |
| if( nal_unit_type != IDR_W_RADL && nal_unit_type != IDR_N_LP | |
| ) { | |
| slice_pic_order_cnt_lsb | u(v) |
| short_term_ref_pic_set_sps_flag | u(1) |
| if( !short_term_ref_pic_set_sps_flag ) | |
| short_term_ref_pic_set( num_short_term_ref_pic_sets ) | |
| else if( num_short_term_ref_pic_sets > 1 ) | |
| short_term_ref_pic_set_idx | u(v) |
| if( long_term_ref_pics_present_flag ) { | |
| if( num_long_term_ref_pics_sps > 0 ) | |
| num_long_term_sps | ue(v) |
| num_long_term_pics | ue(v) |
| for( i = 0; i < num_long_term_sps + num_long_term_pics; i++ ) { | |
| if( i < num_long_term_sps ) { | |
| if( num_long_term_ref_pics_sps > 1 ) | |
| lt_idx_sps[ i ] | u(v) |
| } else { | |
| poc_lsb_lt[ i ] | u(v) |
| used_by_curr_pic_lt_flag[ i ] | u(1) |
| } | |
| delta_poc_msb_present_flag[ i ] | u(1) |
| if( delta_poc_msb_present_flag[ i ] ) | |
| delta_poc_msb_cycle_lt[ i ] | ue(v) |
| } | |
| } | |
| if( sps_temporal_mvp_enabled_flag ) | |
| slice_temporal_mvp_enabled_flag | u(1) |
| } | |
| if( sample_adaptive_offset_enabled_flag ) { | |
| slice_sao_luma_flag | u(1) |
| slice_sao_chroma_flag | u(1) |
| } | |
| if( intra_block_copy_enable_flag ) | |
| num_intra_bc_bvp_cand_minus2 | ue(v |
| if( slice_type = = P \|\| slice_type = = B ) { | |
| num_ref_idx_active_override_flag | u(1) |
| if( num_ref_idx_active_override_flag ) { | |
| num_ref_idx_l0_active_minus1 | ue(v) |
| if( slice_type = = B ) | |
| num_ref_idx_l1_active_minus1 | ue(v) |
| } | |
| if( lists_modification_present_flag && NumPocTotalCurr > 1 ) | |
| ref_pic_lists_modification( ) | |
| if( slice_type = = B ) | |
| mvd_l1_zero_flag | u(1) |
| if( cabac_init_present_flag ) | |
| cabac_init_flag | u(1) |
| if( slice_temporal_mvp_enabled_flag ) { | |
| if( slice_type = = B ) | |
| collocated_from_l0_flag | u(1) |
| if( ( collocated_from_l0_flag && num_ref_idx_l0_active_minus1 | |
| > 0 ) \|\| | |
| ( !collocated_from_l0_flag && num_ref_idx_l1_active_minus1 | |
| > 0 ) ) | |
| collocated_ref_idx | ue(v) |
| } | |
| if( ( weighted_pred_flag && slice_type = = P ) \|\| | |
| ( weighted_bipred_flag && slice_type = = B ) ) | |
| pred_weight_table( ) | |
| five_minus_max_num_merge_cand | ue(v) |
| } | |
| slice_qp_delta | se(v) |
| if( pps_slice_chroma_qp_offsets_present_flag ) { | |
| slice_cb_qp_offset | se(v) |
| slice_cr_qp_offset | se(v) |
| } | |
| if( deblocking_filter_override_enabled_flag ) | |
| deblocking_filter_override_flag | u(1) |
| if( deblocking_filter_override_flag ) { | |
| slice_deblocking_filter_disabled_flag | u(1) |
| if( !slice_deblocking_filter_disabled_flag ) { | |
| slice_beta_offset_div2 | se(v) |
| slice_tc_offset_div2 | se(v) |
| } | |
| } | |
| if( pps_loop_filter_across_slices_enabled_flag && | |
| ( slice_sao_luma_flag \|\| slice_sao_chroma_flag \|\| | |
| !slice_deblocking_filter_disabled_flag ) ) | |
| slice_loop_filter_across_slices_enabled_flag | u(1) |
| } | |
| if( tiles_enabled_flag \|\| entropy_coding_sync_enabled_flag ) { | |
| num_entry_point_offsets | ue(v) |
| if( num_entry_point_offsets > 0 ) { | |
| offset_len_minus1 | ue(v) |
| for( i = 0; i < num_entry_point_offsets; i++ ) | |
| entry_point_offset_minus1[ i ] | u(v) |
| } | |
| } | |
| if( slice_segment_header_extension_present_flag ) { | |
| slice_segment_header_extension_length | ue(v) |
| for( i = 0; i < slice_segment_header_extension_length; i++) | |
| slice_segment_header_extension_data_byte[ i ] | u(8) |
| } | |
| byte alignment( ) | |
| } | |

Prediction unit syntax

| prediction_unit( x0, y0, nPbW, nPbH ) { | Descriptor |
|---|---|
| if( cu_skip_flag[ x0 ][ y0 ]) { | |
| if( MaxNumMergeCand > 1 ) | |
| merge_idx[ x0 ][ y0 ] | ae(v) |
| } else if (intra_bc_flag[ x0 ][ y0 ]){ /* Intra BC*/ | |
| mvd_coding( x0, y0, 2) | |
| if( NumIntraBCBvpCand > 1 ) | |
| intra_bc_bvp_idx [ x0 ][ y0 ] | ae(v) |
| } else { /* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

Semantics
General slice segment header semantics for this embodiment are as follows:
   num_intra_bc_bvp_cand_minus2 plus 2 specifies the number of block vector predictor candidates for Intra block copy. The number of block vector predictor candidates for Intra block copy, NumIntraBCBvpCand is derived as follows:

NumIntraBCBvpCand=num_intra_bc_bvp_cand_minus2+2

The value of NumIntraBCBvpCand shall be in the range of 2 to 5, inclusive.
Alternatively, the value of NumIntraBCBvpCand shall be in the range of 1 to 5, inclusive.
Alternatively, the value of NumIntraBCBvpCand shall be in the range of 2 to 4, inclusive.
Alternatively, the value of NumIntraBCBvpCand shall be in the range of 1 to 4, inclusive.

Prediction Unit Semantics

intra_bc_bvp_idx[x0][y0] specifies the block vector predictor index of the predictor candidate list where x0, y0 specify the location (x0, y0) of the top-left luma sample of the considered prediction block relative to the top-left luma sample of the picture.
When intra_bc_bvp_idx[x0][y0] is not present, it is inferred to be equal to 0.

### Embodiment #11

In embodiment #11, similar to embodiment #10, the number of Intra BC AMVP hypothesis (candidates) is signalled in slice header, but in a different way. The skip mode and merge mode for Intra BC are not supported in this example.

Syntax

General slice segment header syntax for this embodiment are shown in Syntax Table 11.1 below.

SYNTAX TABLE 11.1

| slice_segment_header( ) { | Descriptor |
|---|---|
| first_slice_segment_in_pic_flag | u(1) |
| if( nal_unit_type >= BLA_W_LP && nal_unit_type <= | |
| RSV_IRAP_VCL23 ) | |
| no_output_of_prior_pics_flag | u(1) |
| slice_pic_parameter_set_id | ue(v) |
| if( !first_slice_segment_in_pic_flag ) { | |
| if( dependent_slice_segments_enabled_flag ) | |
| dependent_slice_segment_flag | u(1) |
| slice_segment_address | u(v) |
| } | |
| if( !dependent_slice_segment_flag ) { | |
| for( i = 0; i < num_extra_slice_header_bits; i++ ) | |
| slice_reserved_flag[ i ] | u(1) |
| slice_type | ue(v) |
| if( output_flag_present_flag ) | |
| pic_output_flag | u(1) |
| if( separate_colour_plane_flag = = 1 ) | |
| colour_plane_id | u(2) |
| if( nal_unit_type != IDR_W_RADL && nal_unit_type != | |
| IDR_N_LP ) { | |
| slice_pic_order_cnt_lsb | u(v) |
| short_term_ref_pic_set_sps_flag | u(1) |
| if( !short_term_ref_pic_set_sps_flag ) | |
| short_term_ref_pic_set( num_short_term_ref_pic_sets ) | |
| else if( num_short_term_ref_pic_sets > 1 ) | |
| short_term_ref_pic_set_idx | u(v) |
| if( long_term_ref_pics_present_flag ) { | |
| if( num_long_term_ref_pics_sps > 0 ) | |
| num_long_term_sps | ue(v) |
| num_long_term_pics | ue(v) |
| for( i = 0; i < num_long_term_sps + num_long_term_pics; i++ ) { | |
| if( i < num_long_term_sps ) { | |
| if( num_long_term_ref_pics_sps > 1 ) | |
| lt_idx_sps[ i ] | u(v) |
| } else { | |
| poc_lsb_lt[ i ] | u(v) |
| used_by_curr_pic_lt_flag[ i ] | u(1) |
| } | |
| delta_poc_msb_present_flag[ i ] | u(1) |
| if( delta_poc_msb_present_flag[ i ] ) | |
| delta_poc_msb_cycle_lt[ i ] | ue(v) |
| } | |
| } | |
| if( sps_temporal_mvp_enabled_flag ) | |
| slice_temporal_mvp_enabled_flag | u(1) |
| } | |
| if( sample_adaptive_offset_enabled_flag ) { | |
| slice_sao_luma_flag | u(1) |
| slice_sao_chroma_flag | u(1) |
| } | |
| if( intra_block_copy_enable_flag ) | |
| five_minus_num_intra_bc_bvp_cand | ue(v) |
| if( slice_type = = P \|\| slice_type = = B ) { | |
| num_ref_idx_active_override_flag | u(1) |
| if( num_ref_idx_active_override_flag ) { | |
| num_ref_idx_l0_active_minus1 | ue(v) |
| if( slice_type = = B ) | |
| num_ref_idx_l1_active_minus1 | ue(v) |
| } | |
| if( lists_modification_present_flag && NumPocTotalCurr > 1 ) | |
| ref_pic_lists_modification( ) | |
| if( slice_type = = B ) | |
| mvd_l1_zero_flag | u(1) |
| if( cabac_init_present_flag ) | |
| cabac_init_flag | u(1) |
| if( slice_temporal_mvp_enabled_flag ) { | |
| if( slice_type = = B ) | |
| collocated_from_l0_flag | u(1) |
| if( ( collocated_from_l0_flag && num_ref_idx_l0_active_minus1 | |
| > 0 ) \|\| | |
| ( !collocated_from_l0_flag && num_ref_idx_l1_active_minus1 | |
| > 0 ) ) | |
| collocated_ref_idx | ue(v) |
| } | |
| if( ( weighted_pred_flag && slice_type = = P ) \|\| | |
| ( weighted_bipred_flag && slice_type = = B ) ) | |
| pred_weight_table( ) | |
| five_minus_max_num_merge_cand | ue(v) |
| } | |
| slice_qp_delta | se(v) |
| if( pps_slice_chroma_qp_offsets_present_flag ) { | |
| slice_cb_qp_offset | se(v) |
| slice_cr_qp_offset | se(v) |
| } | |
| if( deblocking_filter_override_enabled_flag ) | |
| deblocking_filter_override_flag | u(1) |
| if( deblocking_filter_override_flag ) { | |
| slice_deblocking_filter_disabled_flag | u(1) |
| if( !slice_deblocking_filter_disabled_flag ) { | |
| slice_beta_offset_div2 | se(v) |
| slice_tc_offset_div2 | se(v) |
| } | |
| } | |
| if( pps_loop_filter_across_slices_enabled_flag && | |
| ( slice_sao_luma_flag \|\| slice_sao_chroma_flag \|\| | |
| !slice_deblocking_filter_disabled_flag ) ) | |
| slice_loop_filter_across_slices_enabled_flag | u(1) |
| } | |
| if( tiles_enabled_flag \|\| entropy_coding_sync_enabled_flag ) { | |
| num_entry_point_offsets | ue(v) |
| if( num_entry_point_offsets > 0 ) { | |
| offset_len_minus1 | ue(v) |
| for( i = 0; i < num_entry_point_offsets; i++ ) | |
| entry_point_offset_minus1[ i ] | u(v) |
| } | |
| } | |
| if( slice_segment_header_extension_present_flag ) { | |
| slice_segment_header_extension_length | ue(v) |
| for( i = 0; i < slice_segment_header_extension_length; i++) | |
| slice_segment_header_extension_data_byte[ i ] | u(8) |
| } | |
| byte_alignment( ) | |
| } | |

Prediction unit syntax for Embodiment #11 are shown in Syntax Table 11.2 below.

SYNTAX TABLE 11.2

| prediction_unit( x0, y0, nPbW, nPbH ) { | Descriptor |
|---|---|
| if( cu_skip_flag[ x0 ][ y0 ]) { | |
| if( MaxNumMergeCand > 1 ) | |
| merge_idx[ x0 ][ y0 ] | ae(v) |
| } else if (intra_bc_flag[ x0 ][ y0 ]){ /* Intra BC*/ | |
| mvd_coding( x0, y0, 2) | |
| if( NumIntraBCBvpCand > 1 ) | |
| intra_bc_bvp_idx [ x0 ][ y0 ] | ae(v) |
| } else { /* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

Semantics

General slice segment header semantics are as follows:

five_minus_num_intra_bc_bvp_cand specifies the number of Intra block copy block vector predictor candidates supported in the slice subtracted from 5. The number of block vector predictor candidates for Intra block copy, NumIntraBCBvpCand is derived as follows:

NumIntraBCBvpCand=5−five_minus_num_intra_bc_bvp_cand

The value of NumIntraBCBvpCand shall be in the range of 1 to 5, inclusive.

Prediction Unit Semantics for this embodiment are as follows:

intra_bc_bvp_idx[x0][y0] specifies the block vector predictor index of the predictor candidate list where x0, y0 specify the location (x0, y0) of the top-left luma sample of the considered prediction block relative to the top-left luma sample of the picture.

When intra_bc_bvp_idx[x0][y0] is not present, it is inferred to be equal to 0.

Certain aspects of this disclosure have been described with respect to the developing HEVC standard for purposes of illustration. However, the techniques described in this disclosure may be useful for other video coding processes, including other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding, as applicable.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising:
determining candidate blocks for a block vector prediction process from a subset of candidate blocks used for an advanced motion vector prediction mode or a merge mode for motion vector prediction process;
performing the block vector prediction process for a block of video data using the determined candidate blocks; and
decoding the block of video data using intra block copy based on the block vector prediction process.

2. The method of claim 1, further comprising:
forming a block vector candidate list for the block of video data, such that the block vector candidate list includes motion information associated with the subset of candidate blocks.

3. The method of claim 2, wherein the subset of candidate blocks includes a left neighbor block and an above neighbor block relative to the block of video data.

4. The method of claim 1, wherein determining the candidate blocks comprises performing the block vector prediction process for the block of video data based on the subset of candidate blocks used for the motion vector prediction process for advanced motion vector prediction mode or merge mode, irrespective of a size of the block of video data.

5. The method of claim 1, further comprising:
forming a block vector candidate list for the block of video data, such that the block vector candidate list includes motion information associated with the subset of candidate blocks;
determining that a number of candidate blocks with available motion information is fewer than a predetermined maximum number of the block vector candidate list; and
responsive to determining that the number of the candidate blocks with the available motion information is fewer than the capacity of the block vector candidate list, generating one or more virtual candidates with which to populate the block vector candidate list.

6. The method of claim 5, wherein generating the one or more virtual candidates comprises using motion information for at least one of:
a block located at position (−2w, 0) with respect to the block of video data, or
a block located at position (−w, 0) with respect to the block of video data, wherein ‘w’ denotes a width of the block of video data.

7. The method of claim 1, wherein determining the candidate blocks comprises:
if an above neighbor block is coded outside of a row of coded tree blocks (CTBs) that includes data for the block of video data, determining that the above neighbor block is unavailable.

8. The method of claim 7, wherein the block of video data is included in an inter-coded slice of video data or in an intra-coded slice of video data.

9. The method of claim 1, wherein the subset of candidate blocks includes two (2) candidate blocks, the method further comprising:
extending the subset of candidate blocks to include greater than the two (2) candidate blocks to form an extended subset; and
forming a block vector candidate list using motion information for each candidate block of the extended subset.

10. The method of claim 9, wherein the extended subset includes a number of candidate blocks between three (3) and five (5).

11. The method of claim 1, wherein the subset of candidate blocks includes a left neighbor block and an above neighbor block with respect to the block of video data, the method further comprising:
deriving motion information for each of the left neighbor block and the above neighbor block using a derivation process defined according to either the advanced motion vector prediction mode or the merge mode; and
forming a block vector candidate list for the block of video data using the derived motion information for each of the left neighbor block and the above neighbor block.

12. The method of claim 1, further comprising:
decoding motion information for the subset of candidate blocks using a context used for the advanced motion vector prediction mode only if the block of video data is included in an inter-coded slice of video data,
wherein the context used for the advanced motion vector prediction mode is a context used for coding inter-coded slices of video data according to the advanced motion vector prediction mode.

13. A method for encoding video data, the method comprising:
determining candidate blocks for a block vector prediction process from a subset of candidate blocks used for an advanced motion vector prediction mode or a merge mode for motion vector prediction process;
performing the block vector prediction process for a block of video data using the determined candidate blocks; and
encoding the block of video data using intra block copy based on the block vector prediction process.

14. The method of claim 13, further comprising:
forming a block vector candidate list for the block of video data, such that the block vector candidate list includes motion information associated with the subset of candidate blocks.

15. The method of claim 14, wherein the subset of candidate blocks includes a left neighbor block and an above neighbor block relative to the block of video data.

16. The method of claim 13, wherein determining the candidate blocks comprises performing the block vector prediction process for the block of video data based on the subset of candidate blocks used for the motion vector prediction process for advanced motion vector prediction mode or merge mode, irrespective of a size of the block of video data.

17. The method of claim 13, further comprising:
forming a block vector candidate list for the block of video data, such that the block vector candidate list includes motion information associated with the subset of candidate blocks;
determining that a number of candidate blocks with available motion information is fewer than a predetermined maximum number of the block vector candidate list; and
responsive to determining that the number of the candidate blocks with the available motion information is fewer than the capacity of the block vector candidate list, generating one or more virtual candidates with which to populate the block vector candidate list.

18. The method of claim 17, wherein generating the one or more virtual candidates comprises using motion information for at least one of:
a block located at position (−2w, 0) with respect to the block of video data, or
a block located at position (−w, 0) with respect to the block of video data, wherein ‘w’ denotes a width of the block of video data.

19. The method of claim 13, wherein determining the candidate blocks comprises:
if an above neighbor block is coded outside of a row of coded tree blocks (CTBs) that includes data for the block of video data, determining that the above neighbor block is unavailable.

20. The method of claim 19, wherein the block of video data is included in an inter-coded slice of video data or in an intra-coded slice of video data.

21. The method of claim 13, wherein the subset of candidate blocks includes two (2) candidate blocks, the method further comprising:
extending the subset of candidate blocks to include greater than the two (2) candidate blocks to form an extended subset; and
forming a block vector candidate list using motion information for each candidate block of the extended subset.

22. The method of claim 21, wherein the extended subset includes a number of candidate blocks between three (3) and five (5).

23. The method of claim 13, wherein the subset of candidate blocks includes a left neighbor block and an above neighbor block with respect to the block of video data, the method further comprising:
deriving motion information for each of the left neighbor block and the above neighbor block using a derivation process defined according to either the advanced motion vector prediction mode or the merge mode; and
forming a block vector candidate list for the block of video data using the derived motion information for each of the left neighbor block and the above neighbor block.

24. The method of claim 13, further comprising:
encoding motion information for the subset of candidate blocks using a context used for the advanced motion vector prediction mode only if the block of video data is included in an inter-coded slice of video data,
wherein the context used for the advanced motion vector prediction mode is a context used for coding inter-coded slices of video data according to the advanced motion vector prediction mode.

25. A device for coding video data, the device comprising:
a memory configured to store video data; and
one or more processors configured to:
determine candidate blocks for a block vector prediction process from a subset of candidate blocks used for an advanced motion vector prediction mode or a merge mode for motion vector prediction process;
perform the block vector prediction process for a block of video data using the determined candidate blocks; and
code the block of video data using intra block copy based on the block vector prediction process.

26. The device of claim 25, wherein the one or more processors are further configured to:
form a block vector candidate list for the block of video data, such that the block vector candidate list includes motion information associated with the subset of candidate blocks.

27. The device of claim 26, wherein the subset of candidate blocks includes a left neighbor block and an above neighbor block relative to the block of video data.

28. The device of claim 25, wherein, to determine the candidate blocks, the one or more processors are configured to perform the block vector prediction process for the block of video data based on the subset of candidate blocks used for the motion vector prediction process for advanced motion vector prediction mode or merge mode, irrespective of a size of the block of video data.

29. The device of claim 25, wherein the one or more processors are further configured to:
form a block vector candidate list for the block of video data, such that the block vector candidate list includes motion information associated with the subset of candidate blocks;
determine that a number of candidate blocks with available motion information is fewer than a predetermined maximum number of the block vector candidate list; and
responsive to the determination that the number of the candidate blocks with the available motion information is fewer than the capacity of the block vector candidate list, generate one or more virtual candidates with which to populate the block vector candidate list.

30. The device of claim 29, wherein, to generate the one or more virtual candidates, the one or more processors are configured to use motion information for at least one of:
a block located at position (−2w, 0) with respect to the block of video data, or
a block located at position (−w, 0) with respect to the block of video data, wherein ‘w’ denotes a width of the block of video data.

31. The device of claim 25, wherein, to determine the candidate blocks, the one or more processors are configured to:
if an above neighbor block is coded outside of a row of coded tree blocks (CTBs) that includes data for the block of video data, determine that the above neighbor block is unavailable.

32. The device of claim 31, wherein the block of video data is included in an inter-coded slice of video data or in an intra-coded slice of video data.

33. The device of claim 25, wherein the subset of candidate blocks includes two (2) candidate blocks, and wherein the one or more processors are further configured to:
extend the subset of candidate blocks to include greater than the two (2) candidate blocks to form an extended subset; and
form a block vector candidate list using motion information for each candidate block of the extended subset.

34. The device of claim 33, wherein the extended subset includes a number of candidate blocks between three (3) and five (5).

35. The device of claim 25, wherein the subset of candidate blocks includes a left neighbor block and an above neighbor block with respect to the block of video data, wherein coding the video data comprises decoding the video data, and wherein the one or more processors are further configured to:
derive motion information for each of the left neighbor block and the above neighbor block using a derivation process defined according to either the advanced motion vector prediction mode or the merge mode; and
form a block vector candidate list for the block of video data using the derived motion information for each of the left neighbor block and the above neighbor block.

36. The device of claim 25, wherein the one or more processors are further configured to:
code motion information for the subset of candidate blocks using a context used for the advanced motion vector prediction mode only if the block of video data is included in an inter-coded slice of video data,
wherein the context used for the advanced motion vector prediction mode is a context used for coding inter-coded slices of video data according to the advanced motion vector prediction mode.

37. The device of claim 25,
wherein, to code the block of video data using intra block copy based on the block vector prediction process, the one or more processors are configured to decode the block of video data using intra block copy based on the block vector prediction process to form decoded video data, the device further comprising:
a display configured to output the decoded video data for display.

38. A non-transitory computer-readable storage medium encoded with instructions that, when executed, cause one or more processors of a video coding device to:
determine candidate blocks for a block vector prediction process from a subset of candidate blocks used for an advanced motion vector prediction mode or a merge mode for motion vector prediction process;
perform the block vector prediction process for a block of video data using the determined candidate blocks; and
code the block of video data using intra block copy based on the block vector prediction process.

39. An apparatus for coding video data, the apparatus comprising:
means for determining candidate blocks for a block vector prediction process from a subset of candidate blocks used for an advanced motion vector prediction mode or a merge mode for motion vector prediction process;
means for performing the block vector prediction process for a block of video data using the determined candidate blocks; and
means for coding the block of video data using intra block copy based on the block vector prediction process.
